(19) United States
(12) Patent Application Publication
(10) Pub. No.: US 2026/0254140 A1
(43) Pub. Date: Aug. 27, 2026

(54) INTERCONNECT MODULE ASSEMBLY

(71) Applicant: SAMTEC, INC., New Albany, IN (US)

(72) Inventors: John A. MONGOLD, New Albany, IN (US); Marc EPITAUX, New Albany, IN (US); Ronald KETWITZ, New Albany, IN (US)

(21) Appl. No.: 18/878,149

(22) PCT Filed: Jun. 29, 2023
(86) PCT No.: PCT/US2023/069329

§ 371 Date: Dec. 23, 2024

Related U.S. Application Data
(60) Provisional application No. 63/367,252, filed on Jun. 29, 2022.

(51) Int. Cl. H01R 12/70; H01R 12/75; H01R 13/6471

(52) U.S. Cl. CPC H01R 12/7058; H01R 12/75; H01R 13/6471

(57) ABSTRACT

An interconnect module and mating ring socket that form a vertical insertion interconnect module assembly are described. The interconnect module may be an optical transceiver, transmitter, or receiver that is part of an optical communication system. The interconnect module has a detachable cable assembly secured to the interconnect module by a cable latch. A slidable ring socket latch secures the interconnect module to the ring socket. A cable latch that secures the detachable cable assembly to the interconnect module has a pivot axis that can shift its position to facilitate latching and unlatching of the detachable cable assembly.

### CROSS-REFERENCE TO RELATED APPLICATIONS

This claims priority to U.S. patent application Ser. No. 63/367,252 filed Jun. 29, 2022, the disclosure of which is hereby incorporated by reference as if set forth in its entirety herein.

### BACKGROUND

Interconnect modules are used to transmit information between two points in a communication system. The use of optical interconnect modules, instead of electrical interconnects, provides a significant gain in terms of bandwidth distance product and power dissipation reduction. Optical interconnect modules can take the form of an optical transceiver, optical transmitter, or optical receiver. Optical transceivers interface with optical fibers, one or more of which are optical receive fibers that are configured to receive optical input signals, and one or more fibers of which are optical transmit fibers that are configured to transmit optical output signals. In some cases, a single fiber can be configured as both a transmit and receive fiber to enable bidirectional communication over a single fiber.

In some cases, the optical fibers plug into the optical transceiver, whereas in other cases the optical fibers are permanently attached (commonly known as pigtailed) to the optical transceiver. Interconnect modules having pluggable optical fibers are often desirable, since the fiber pigtail is often awkward during shipping, handling and installation of the interconnect module. Moreover, if a fiber breaks during manufacturing or when mounted in a system, the entire module needs to be scrapped.

Optical transceivers further include electrical contacts, one or more of which being electrical receive contacts that are configured to receive electrical input signals (transmitter side), and one or more of which electrical transmit contacts that are configured to transmit electrical output signals (receiver side). The electrical contacts of the transceiver are configured to mate with complementary electrical contacts of an electrical device, such as an electrical connector or socket that is, in turn, is mounted to a host substrate that can be configured as a printed circuit board (PCB).

Optical transceivers include an optical transmitter that receives the electrical input signals and activates a light source to generate the optical output signals to the optical transmit fibers for use in a communication system. The optical output signals correspond to the received electrical input signals. The light source is typically a laser light source, such as a VCSEL (Vertical Cavity Surface Emitting Laser) or some other type of laser. The laser can be directly modulated, or the laser can operate in a continuous wave (CW) manner and be modulated thereafter by a modulator (Mach Zehnder, Ring Resonator, Electro-Absorptive modulators). In some cases, the optical transmitter includes a voltage-to-current converter, such as a driver that amplifies and converts the modulated input electrical voltage signals to output a driving current to the VCSEL which effectively modulates its light output. The driver is typically constructed as an integrated circuit (IC) die. For light sources operating in a CW manner, an IC may be used to generate a constant current to the light source, producing a constant output light level, and another circuit, would typically provide a modulation signal to drive the modulator. The modulation circuit may be a separate IC or may be integrated into the light source driving IC.

Optical transceivers further include an optical receiver that receives the optical input signals and converts the optical input signals to electrical output signals that correspond to the received optical input signals. The optical receiver typically includes one or more photodetectors, such as photodiodes, that receive optical input signals and convert the optical input signals to electrical signals that can have current levels proportional with the quantity of optical photons per unit time received in the optical signals. The optical receiver further typically includes a current-to-voltage converter, such as a transimpedance amplifier (TIA) that amplifies and converts the electrical current signals to voltage levels that are usable in data communication systems. The TIA is typically constructed as an integrated circuit (IC) die.

As noted above, an optical transceiver includes both a transmitter and receiver.

The transmitter can be mechanically separate from the receiver. Alternatively, the transmitter can be mechanically integrated with the receiver. The light source of the transmitter and photodiode of the receiver may generally be referred to as electro-optical elements since they all are involved either with the conversion of an electrical signal to an optical signal or vice versa.

Unfortunately, light source performance, such as VCSEL performance, is degraded by operating at elevated temperatures. Depending on the type of VCSEL used, operating VCSELs at temperatures exceeding 70° C., 80° C., 85° C. or 100° C. may result in unacceptable VCSEL lifetime or electrical-to-optical conversion efficiency. Generally, the upper limit of the VCSEL operating temperature is significantly lower than the operating temperature limit of its associated IC, which may be situated adjacent the VCSEL. For example, the IC may have an operating temperature limit of 100° C. or 125° C. While the IC can withstand a higher operating temperature, it typically generates an order of magnitude more waste heat than the VCSEL. For example, in operation the IC may generate 2.0 W of waste heat while the VCSEL may only generate 0.1 W of waste heat. Thus, efficient heat removal is an important consideration in implementation of a transceiver.

Conventional interconnect modules, such as those described in Patent Cooperation Treaty publication No. WO2022081683 describe various methods and arrangements for latching a detachable optical fiber cable to a transceiver and latching an interconnect module to a mating ring socket. While the methods and arrangements described in this application work well, they have limitations is some applications. In particular, the latching arrangement of the interconnect module to the ring socket must be performed prior to installation of a heat sink on the interconnect module. It would be advantageous if an interconnect module could be mated and unmated without removal of the heat sink.

### SUMMARY

In a first embodiment, an interconnect module comprising a rectangular module substrate, a connector housing having two opposing sides and two opposing ends mounted to the module substrate, a module frame mounted to the module substrate, and a cable latch carried by the module frame are described. The connector housing can support first and second rows of electrical contacts arranged on the opposing sides of the connector housing, and the cable latch can be permanently attached to the interconnect module. The interconnect module is configured to accept a cable ferrule that is part of a detachable cable assembly, which is secured against an optical block in the interconnect module by the cable latch when the cable ferrule is mated with the interconnect module.

In a second embodiment, a ring socket comprising an electrically insulative ring socket housing having two opposing sides and a first end and an opposed second end that form a rectangular opening is described. The ring socket housing has two rows of electrical contacts mounted in the two opposing sides of the ring socket housing. The ring socket further comprises a slidable ring socket latch that protrudes from the second end of the ring socket housing.

In a third embodiment, a vertical insertion interconnection assembly is described. The vertical insertion interconnection assembly is comprised of an interconnect module including a cable latch configured to secure a detachable cable assembly to the interconnect module and a ring socket including a ring socket latch configured. to secure the interconnect module to the ring socket.

### BRIEF DESCRIPTION OF DRAWINGS

The following detailed description will be better understood when read in conjunction with the appended drawings, in which there is shown in the drawings example embodiments for the purposes of illustration. It should be understood, however, that the present disclosure is not limited to the precise arrangements and instrumentalities shown. In the drawings:

FIG. 1A is an exploded perspective view of an interconnect module assembly including a ring socket and an interconnect module aligned to be mated with the ring socket in one example, showing a ring socket latch of the ring socket in an accept position;

FIG. 1B is a perspective view of the ring socket of FIG. 1A, showing the ring socket latch in a locked position;

FIG. 1C is a perspective view of the ring socket of FIG. 1A, showing the ring socket latch in an eject position;

FIG. 2A is a perspective view of an interconnect module assembly having an interconnect module mated with a ring socket according to one example;

FIG. 2B is another perspective view of the interconnect module assembly of FIG. 2A;

FIG. 2C is a perspective view of the ring socket similar to FIG. 2A, but showing the latch constructed in another example;

FIG. 3A is a bottom perspective view of an interconnect module with a connected cable according to one example;

FIG. 3B is an exploded perspective view of the interconnect module of FIG. 3A;

FIG. 4A is a top perspective view of an interconnect module with a connected cable according to one example;

FIG. 4B is a sectional side elevation view of a portion of the interconnect module of FIG. 4A;

FIG. 5 is a perspective view of a vertical insertion interconnection assembly with an installed heat sink according to one example;

FIG. 6A shows a perspective view of aa portion of the interconnect module having a cable latch positioned to accept a cable assembly;

FIG. 6B shows a perspective view of a cable latch in its locked position mating a cable ferrule to the interconnect module according to one example;

FIG. 6C shows a cut-away perspective view of a cable latch in its locked position according to one example;

FIG. 7 shows a perspective view of a cable latch according to one example;

FIG. 8A is a sectional side elevation view of the interconnect module with a cable ferrule mated thereto, showing a cable latch in an open position in one example;

FIG. 8B is a sectional side elevation view similar to FIG. 8A, but showing the cable latch moving to a closed position in one example;

FIG. 8C is a sectional side elevation view similar to FIG. 8B, but showing the cable latch in the closed position;

FIG. 9 shows a perspective view of an interconnect module mated with a cable assembly according to one example;

FIG. 10, shows a cross-sectional view of an interconnect module mated with a cable assembly according to one example;

FIG. 11 is a bottom perspective view of an interconnect module positioned adjacent a ring socket with a ring socket latch in an accept position according to one example;

FIG. 12 shows a cross-sectional, end view of an interconnect module positioned above a ring socket according to one example;

FIG. 13 shows a perspective view of a connector housing according to one example;

FIG. 14 shows a perspective view of a ring socket latch according to one example;

FIG. 15A is a perspective view of a module frame according to one example;

FIG. 15B is another perspective view of a module frame of FIG. 15A;

FIG. 15C is a sectional side elevation view of the module frame of FIG. 15A;

FIG. 15D is a bottom plan view of the module frame of FIG. 15A;

FIG. 16A is a cross-sectional perspective view of the interconnect module mated with the ring socket housing, but showing the latch in the accept position;

FIG. 16B is a cross-sectional perspective view of the interconnect module mated with the ring socket housing, showing the latch in a locked position according to one example;

FIG. 16C is a cross-sectional perspective view showing the interconnect module being unmated from the ring socket housing, with the latch in the eject position;

FIG. 17 is an exploded perspective view of an interconnect module assembly including a ring socket and an electrical interconnect module aligned to be mated with the ring socket in one example;

FIG. 18A is a perspective view of the electrical interconnect module illustrated in FIG. 17;

FIG. 18B is an exploded perspective view of the electrical interconnect module illustrated in FIG. 18A;

FIG. 18C is a perspective view of the electrical interconnect module similar to FIG. 18A, but showing the cables organized in accordance with another example;

FIG. 19A is an exploded perspective view of an interconnect module housing of the interconnect module of FIG. 18A, showing first and second rails;

FIG. 19B is sectional side elevation view of one of the rails of FIG. 19A;

FIG. 19C is a top plan view of the interconnect module housing of FIG. 19A;

FIG. 20A is a cross-sectional perspective view of the interconnect module mated with the ring socket housing, but showing the latch in the accept position;

FIG. 20B is a cross-sectional perspective view of the interconnect module mated with the ring socket housing, showing the latch in a locked position according to one example; and

FIG. 20C is a cross-sectional perspective view showing the interconnect module being unmated from the ring socket housing, with the latch in the eject position.

### DETAILED DESCRIPTION

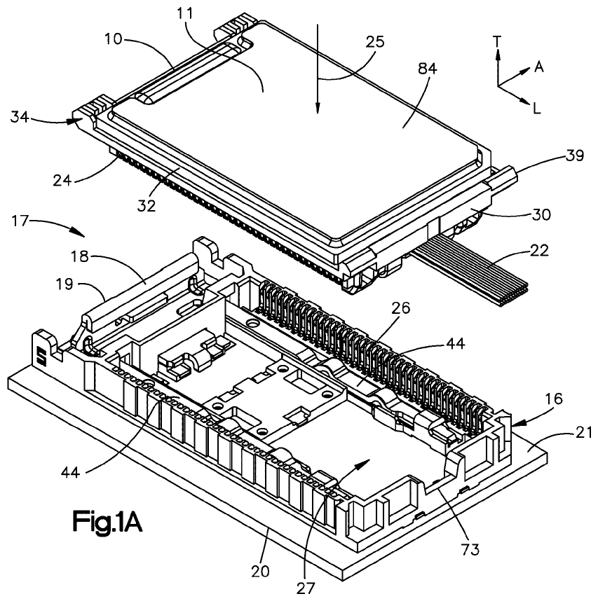

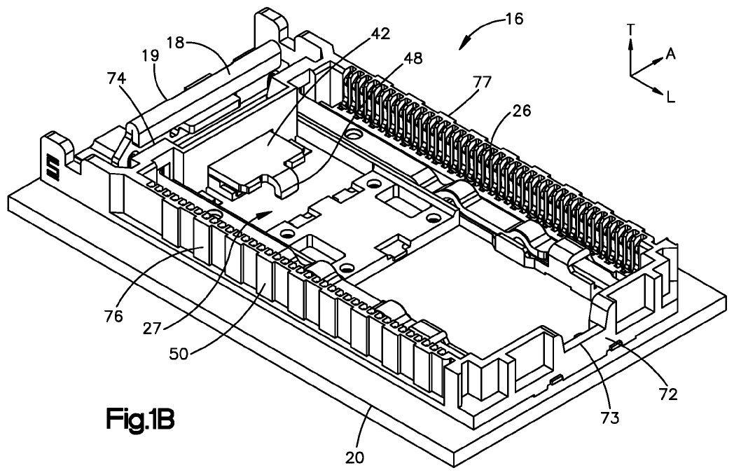

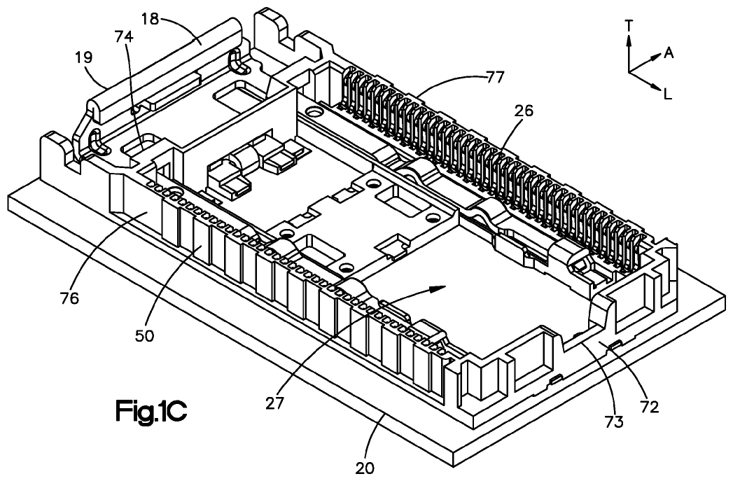

Referring initially to FIGS. 1A-1C, a vertical insertion interconnect assembly 17 includes an interconnect module 10 and a complementary electrical connector, which can be configured as a ring connector, such as a ring socket 16. The interconnect module 10 is configured to mate with the complementary electrical connector as described below. In this regard, description herein with respect to the ring socket 16 can apply with equal force and effect to any suitable alternatively configured electrical connector. The ring socket 16 includes an electrically insulative annular ring socket housing 50 and a plurality of ring electrical contacts 26 supported by the ring socket housing 50. The ring socket 16 may be mounted to a host substrate 20, such as a host printed circuit board, so as to place the ring electrical contacts 26 in electrical communication with electrical traces of the host substrate 20. In particular, the ring socket 16 can be mounted to a major surface 21 of the host substrate 20. The ring socket 16 may be mounted to the host substrate 20 by solder, press-fit pins, or by any other means that provides mechanical and electrical connections between the host substrate 20 and the ring socket 16. The ring socket 16 can define an internal void 27 that is configured to receive the interconnect module so as to mate the ring socket 16 with the interconnect module 10, which causes the ring electrical contacts 26 to mate with module electrical contacts 24 of the interconnect module 10. Thus, the ring socket 16 and the interconnect module 10 as placed in electrical communication with each other when the interconnect module 10 is mated to the ring socket 16. In one example, the interconnect module 10 can bottom out against the ring socket 16 or host substrate 20 when the interconnect module 10 is mated with the ring socket 16.

The ring socket 16 can further include a ring socket latch 18 slidably coupled to the ring socket housing 50. The latch 18 can be selectively movable with respect to the ring socket housing 50 to a first or accept position (FIG. 1A), a second or locked position (FIG. 1B), and a third or eject position (shown in FIG. 1C). In one example, the ring socket latch 18 is slidable with respect to the ring socket housing 50 so as to be selectively positioned in the accept position, the locked position, and the eject position along a longitudinal direction L. The ring socket latch 18 can include an actuator member which can be configured as a latch actuator 19, such as an actuator tab that can be configured as a pull tab, or any suitable alternatively constructed actuator member, that receives an actuation force sufficient to cause the ring socket latch 18 to move. Thus, a position of the ring socket latch 18 may be adjusted by a user pushing or pulling on the latch actuator 19.

The ring socket latch 18 can be movable bidirectionally along a select direction, for instance slidable in pure translation along the longitudinal direction L, with respect to the ring socket housing 50 so as to be selectively positioned in the accept position, the locked position, and the eject position. In one example, the first or accept position can correspond to a position of the ring socket latch 18, and in particular the latch actuator 19, in an intermediate position with respect to the ring socket housing 50 along the lateral direction L. The eject position can correspond to a position of the ring socket latch 18 being in its most extended position with the latch actuator 19 being maximally spaced from a ring socket housing 50 along the select direction, which can be defined by the longitudinal direction L. In the locked position of the ring socket latch 18, the latch actuator 19 is minimally spaced from the ring socket housing 50 along the select direction. The latch actuator 19 in the accept position can be disposed between the lock position and the eject position. Otherwise stated, the latch actuator 19 in the locked position is closer to the ring socket housing 50 along the longitudinal direction L with respect to the accept position. In the accept position, the latch actuator 19 is disposed closer to the ring socket housing 50 along the longitudinal direction L with respect to the eject position.

Therefore, by sliding the latch actuator 19 from the accept position in a longitudinally first or forward direction, for instance toward the ring socket housing 50, the ring socket latch 18 can be placed in the locked position shown in FIG. 1B. In the locked position, the latch actuator 19 can have a minimal spacing between the latch actuator 19 and the ring socket housing 50. By sliding the latch actuator 19 from the accept position shown in FIG. 1A in a longitudinally second or rearward direction opposite the first direction, for instance away from the ring socket housing 50, the ring socket latch 18 may be placed in the eject position shown in FIG. 1C. For instance, the latch actuator 19 can be moved in the second direction from the locked position to the accept position, and further moved in the second direction to the eject position. The first and second directions can be oriented along the longitudinal direction L. It should be appreciated, of course, that the ring socket latch 18 can be alternatively configured as desired.

When the ring socket latch 18 is in the accept position shown in FIG. 1A, the ring socket 16 is configured to accept or mate with an interconnect module 10 in the internal void 27 such that the module electrical contacts 24 of the interconnect module 10 mate with respective ones of the electrical contacts 26 of the ring socket 16. The interconnect module 10 can mate with the ring socket 16 in a mating direction 25 that is oriented in a downward direction along a transverse direction T that is perpendicular to the longitudinal direction L. In the orientation shown in FIGS. 1A-1C, the transverse direction T can define a vertical direction, and thus the ring socket 16 may be said to be configured to accept an interconnect module along a vertical insertion direction. The mating direction 25 can thus be substantially perpendicular to the major surface 21 of the host substrate 20 to which the ring socket 16 is mounted. It is appreciated, of course, that the actual orientation of the interconnect module 10 and ring socket 16 can change during use.

When the ring socket latch 18 is in the locked position shown in FIG. 1B, the ring socket 16 is configured to lock or secure the interconnect module 10 so that the interconnect module 10 is mated to the ring socket 16 and cannot be removed from the ring socket 16 without moving the latch actuator 19 out of the locked position away from the ring socket housing 50, for instance to the eject position. In the accept position, the ring socket 16 unlocks the interconnect module 10 from the ring socket 16. Thus, the interconnect module 10 can be removed from the ring socket 16 by applying a suitable force to the interconnect module 10 in an unmate direction that separates the interconnect module 10 from the ring socket 16. The unmate direction is opposite the mating direction 25 and thus oriented in an upward direction along the transverse direction T. Thus, the downward direction can be referred to as the mating direction and vice versa, and the upward direction can be referred to as the unmate direction as vice versa. The upward and downward directions are thus opposite each other along the transverse direction T. Moving the latch actuator 19 to the eject position causes the ring socket 16, and in particular the ring socket latch 18, to urge the interconnect module 10 to move out of the ring socket 16 in the unmate direction, which disengages the interconnect module 10 from the ring socket 16. With the interconnect module 10 ejected from the ring socket 16, the interconnect module 10 can be easily removed from the ring socket 16. Each of these positions of the ring socket latch 18 is described in more detail below. It should be appreciated that the terms “upward” and “downward” are used with reference to the interconnect module 10 and ring socket 16 in their illustrated orientation, it being understood that the orientations can change during use. The terms “upward” and “downward” thus apply to the interconnect module 10 and the ring socket 16 regardless of the orientations of the interconnect module 10 and the ring socket 16 during use.

The ring socket latch 18 can include a retention member that is configured to interfere with the ring socket housing 50 so as to prevent inadvertent separation from the interconnect module 10 from the ring socket housing. In one example, the retention member can be configured as a retention arm 42 and a retention hook 48 that extends from the retention arm 42. The retention hook 48 may be formed after the ring socket latch 18 has been inserted into the ring socket housing 50. The retention hook 48 can interfere with the ring socket housing 50 so as to prevent the ring socket latch 18 from being removed from the ring socket housing 50 in the second direction.

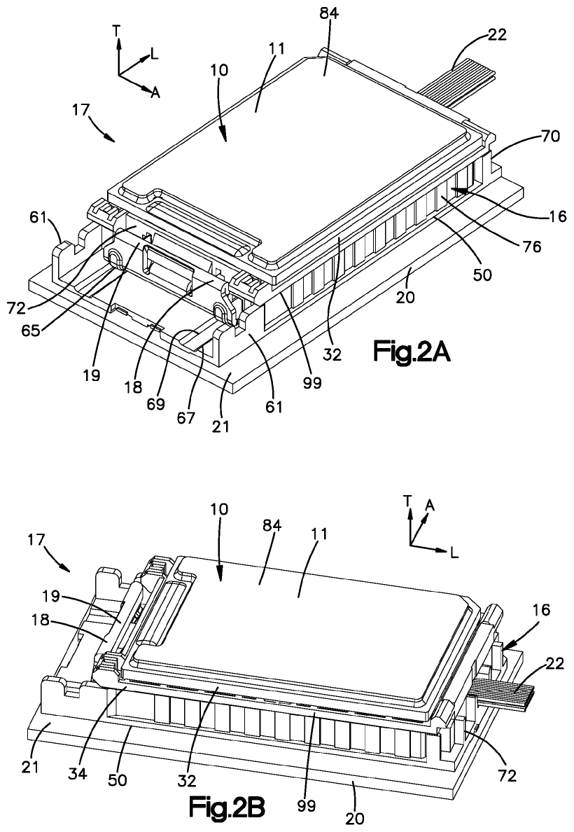

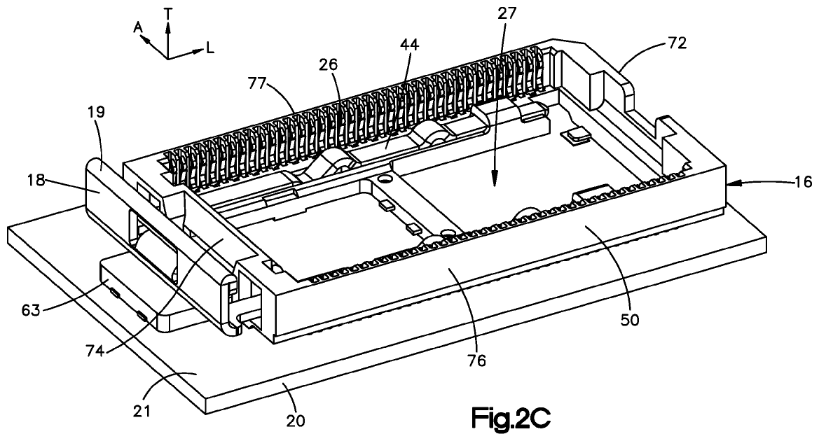

With continuing reference to FIGS. 1A-1C, the ring socket housing 50 may be electrically insulative and may form a ring in a plane that is defined by the longitudinal direction L and a lateral direction A that is orthogonal to the transverse direction T, and is thus perpendicular to each of the longitudinal direction and the transverse direction T. The ring socket housing 50 can define longitudinal ends defined by a first ring socket end 72 and a second ring socket end 74 that is opposite the first ring socket end 72 along the longitudinal direction L. The first ring socket end 72 can define a gap 73 that provides clearance to receive a cable of a detachable cable assembly in an insertion direction as described below (see also FIG. 2B). The latch actuator 19 may protrude from the second end 74 of the ring socket housing 50. Thus, the gap 73 and the latch actuator 19 can be disposed at opposite ends of the ring socket 16 with respect to the longitudinal direction L.

The first or forward direction can be defined as a direction along the longitudinal direction from the second end 74 toward the first end 72. The second direction or rearward direction can be defined as a direction along the longitudinal direction L from the first end 72 toward the second end 74. Thus, a front end of the ring socket housing 50 can be defined by the second end 74, and a rear end of the ring socket housing 50 can be defined by the first end 72. It should be appreciated that the terms “front” and derivatives thereof used with respect to any component, such as the interconnect module 10, refer to a location in the forward direction, and the term “rear” and derivatives thereof refer to a location in the rearward direction. Thus, a front portion can be spaced from a rear portion in the forward direction. Conversely, a rear portion can be spaced from the front portion in the rearward direction.

The ring socket housing 50 can define a first ring socket side 76 and a second ring socket side 77 that each extend between the first and second ring socket ends 72 and 74 along the longitudinal direction L. For instance, the first ring socket side 76 and a second ring socket side 77 can each extend from the first ring socket end 72 to the second ring socket end 74 along the longitudinal direction L. The first and second ring socket sides 76 and 77 can be opposite each other along the lateral direction A. The ring socket 16 defines a width from the first ring socket side 76 to the second ring socket side along the lateral direction A,. The ring socket 16 can define a length from the first ring socket end 72 to the second ring socket end 74 along the longitudinal direction L. The width can be less than the length.

The electrically insulative ring socket housing 50 can support the plurality of ring electrical contacts 26, which can be arranged in respective rows. For instance, the first and second ring socket sides 76 and 77 can each carry respective rows of the ring electrical contacts 26. The ring electrical contacts 26 can be constructed substantially identical (i.e., within manufacturing tolerance) to each other. Each of the respective rows of ring electrical contacts 26 can be oriented parallel to each other. For instance, the rows can be arranged along respective linear arrays that extend along the longitudinal direction L. The ring electrical contacts 26 can define mating ends that face the internal void 27. The ring electrical contacts 26 can be supported by each of the first and second ring socket sides 76 and 77. The ring socket 16 can be devoid of ring electrical contacts 26 along the first and second ring socket ends 72 and 74. Thus, it can be said that the ring electrical contacts 26 of the ring socket 16 can be arranged along the two long sides of the ring socket 16. The ring electrical contacts 26 may be arranged to have a uniform pitch between adjacent contacts. The two short sides of the ring socket 16 may be devoid of ring electrical contacts 26. Thus, first and second rows of the ring electrical contacts 26 can be supported by the first and second ring socket sides 76 and 77, respectively. It should be appreciated that, in one example, all rows of ring electrical contacts 26 can be retained by a single body ring socket housing 50. Alternatively, the ring socket 16 can include at least first and second bodies that support respectively the first and second rows of ring electrical contacts 26. Each of the first and second bodies can be linked together by at least one ring socket mechanical link member, which can be disposed at one or both of the respective longitudinal ends of the ring socket 16.

Ring socket mechanical members, such as the first and second ring ends 72 and 74 can connect to the first and second ring sides 76 and 77 of the ring socket 16 thereby forming the annular ring shaped ring socket housing 50 that defines the internal void 27. The first ring end 72 and second ring end 74 can thus be referred to as first and second linking members that extend from respective first and second longitudinal ends of each row of module electrical contacts 26, such as respective first and second longitudinal ends of the first and second ring sides 76 and 77, so as to form the internal void 27. The ends 72 and 74 and the sides 76 and 77 can combine to define a rectangular shape in cross section in a plane that is orthogonal to the transverse direction T. Thus, the internal void 27 can be rectangular in shape along the plane that is orthogonal to the transverse direction T, or can define any suitable alternative shape as desired. The first and second ends 72 and 74 can be mechanically attached to the respective ends of the first and second ring sides 76 and 77 in one example. In other examples, the ring socket housing 50 may be a unitary monolithic structure.

With continuing reference to FIGS. 1A-1C, each row of ring electrical contacts 26 can include any number of electrical contacts as desired. For instance, each row can contain twenty-five ring electrical contacts 26. Each row can be designed to support high speed differential signals. The electrical contacts 26 can be assigned in any suitable pattern along the row as desired. For instance, the pattern can be a repeating GSSGSSG pattern, a repeating GSS pattern, a repeating GSSGGSSG pattern, or any suitable alternative pattern whereby G represents a ground contact and S represents a signal contact. Alternatively still, the ring electrical contacts 26 can define an unassigned open pin field contacts. As shown, ring socket 16 may be capable of carrying at least eight differential signal pairs suited for transmitting data between 1 and 112 Gbps or more and up to twelve low speed signals and power supply voltages. At least twelve, at least sixteen or more differential signal pairs are other options for ring socket 16 having a larger number of ring electrical contacts 26 than the ring socket 16 shown in FIG. 1A. The length, width, and number of ring electrical contacts 26 of the ring socket 16 can be sized to accommodate a corresponding interconnect module.

As shown in FIG. 1A, the interconnect module 10 is shown positioned above the ring socket 16 and aligned to be mated with the ring socket 16 in the mating direction 25. The interconnect module 10 may be a low-profile, electrical connector mounted to a module substrate 32. The module substrate 32 can be oriented parallel with the host substrate 20. The interconnect module 10 can selectively mate with and unmate from the ring socket in the respective mating and unmate directions that can be substantially normal to the major upper surface 21 of the host substrate 20 to which the ring socket 16 is mounted. The interconnect module 10 can include an electrically insulative module body 39 and a plurality of module electrical contacts 24 supported by the module body 39. In this regard, the module body 39 can also be referred to as a connector housing that supports the plurality of module electrical contacts 24. The module electrical contacts 24 can be mounted to the module substrate 32, which can be configured as a printed circuit board. Thus, the module electrical contacts 24 can be in electrical communication with respective electrical traces of the module substrate 32. A heat spreader 84 can be mounted to the module substrate 32 to dissipate heat generated by the interconnect module 10 during operation. The heat spreader 84 can define a top surface 11 of the interconnect module 10.

A portion of the interconnect module 10 can nest in the ring socket 16 when the interconnect module 10 is mated to the ring socket. Thus, the interconnect assembly 17 can have a low profile along the transverse direction T. In one example, the interconnect assembly 17 can define a height from the bottom surface of the host substrate 20 to the top surface 11 The height can be between 3 mm and 10 mm, such as between 4 mm and 8 mm, such as between 5 mm and 7 mm. In one example, the height can be between 6 mm and 7 mm, such as between 6 mm and 6.5 mm.

The ring socket 16, and in particular the ring socket housing 50 and the rows of ring electrical contacts 26, can be configured to fully constrain the interconnect module 10 along all directions substantially parallel to the major surface 21 of the host substrate 20 when the interconnect module 10 is mated with the ring socket 16. That is, the ring socket 16 can be configured to constrain the interconnect module 10 along each of the longitudinal direction L and the lateral direction A. Further, the ring socket latch 18 of the ring socket 16 can prevent the interconnect module 10 from unmating from the ring socket 16 along the transverse direction T.

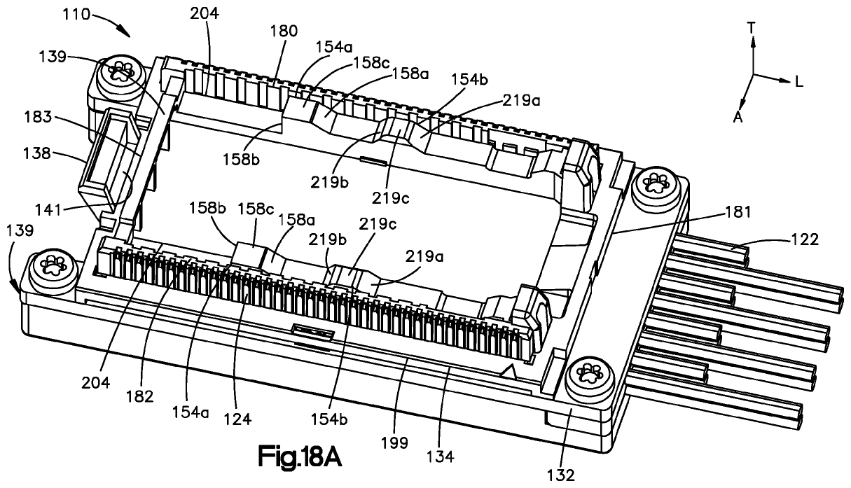

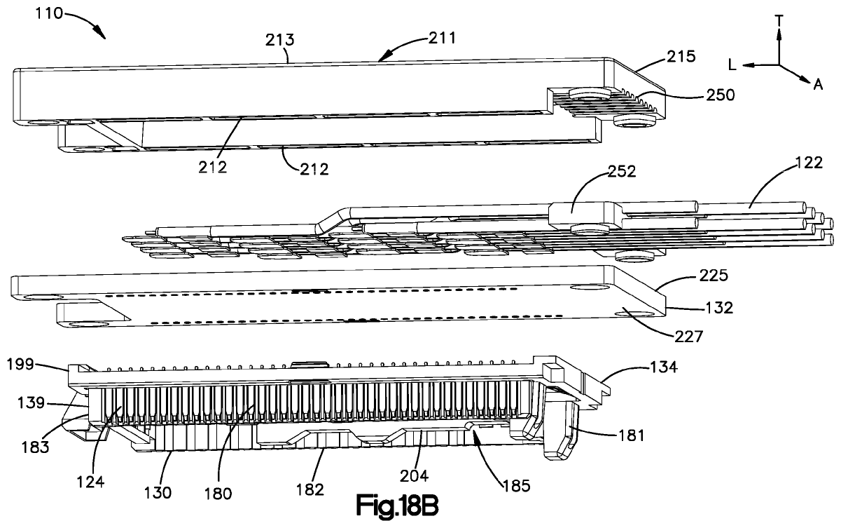

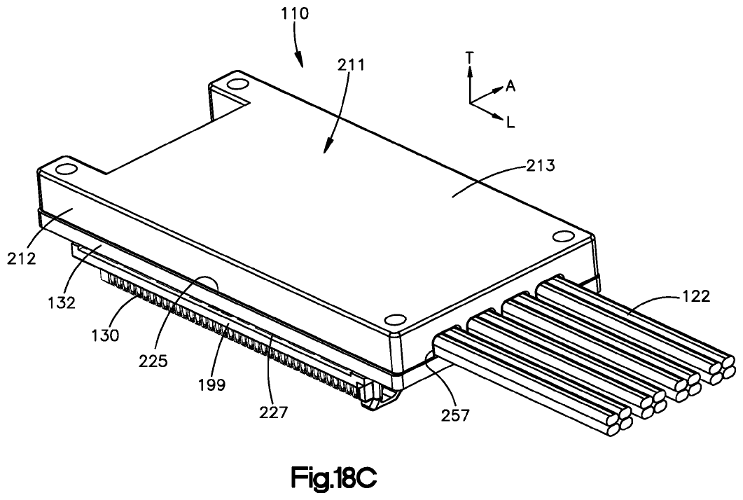

The module electrical contacts 24 may be arranged in first and second rows on opposing sides of the interconnect module 10. The rows of the module electrical contacts 24 can be spaced apart along the lateral direction A. Further, adjacent ones of the module electrical contacts 24 of each row may be separated from each other by a constant pitch along the longitudinal direction L. The module electrical contacts 24 are configured to physically contact the ring electrical contacts 26 and provide an electrical connection between them when interconnect module 10 is mated with the ring socket 16. The interconnect module 10 may include cables 22 that extend out from a longitudinal end of the module body 39 along the longitudinal direction L. As will be described in more detail below, the cables 22 may be detachable, such that they may be mated and unmated from the interconnect module 10. The cables 22 may have a plurality of optical fibers arranged in one or more rows. Thus, the interconnect module 10 can be referred to as an optical interconnect module. Alternatively, as described in more detail below with respect to FIGS. 17-18B, the interconnect module 10 can alternative be configured as an electrical interconnect module 110 whereby the cable 22 may include of a plurality of electrical cables, such as twinaxial cables or coaxial cables. Alternatively, the interconnect module 10 can be a hybrid interconnect module, whereby the cables 22 include a combination of both optical fibers and electrical cables.

Therefore, the interconnect module 10 may be an electrical or optical transceiver that includes a receiver and a transmitter, an electrical or optical receiver, or an electrical or optical transmitter. As a transmitter, the interconnect module 10 is configured to receive electrical signals from the host substrate 20 through the ring electrical contacts 26 when the interconnect module is mated with the ring socket 16, convert the electrical signals to optical signals, and transmit the optical signals along the cable 22 to an external device. As a receiver, the interconnect module 10 is configured to receive optical signals from the cable 22, convert the optical signals to electrical signals, and direct the electrical signals to the host substrate 20 through the ring electrical contacts 26. The interconnect module 10 is configured to mate with the ring socket 16 to form the interconnect assembly 17 for high-speed data transmission. When the ring socket 16 is mounted to the host substrate 20 and the interconnect module 10 is mated to the ring socket 16, the interconnect module 10 is placed in data communication, such as electrical communication, with the host substrate 20. The interconnect module 10 can be arranged to vertically mate with the ring socket 16, in the illustrated transverse direction T. A signal connection between the interconnect module 10 and a corresponding receptacle connector, such as ring socket 16, can be electrical in nature and can be established by mating at least one electrically conductive contact, such as a ring electrical contact, in the ring socket 16 with at least one corresponding electrically conductive module contact 24 in the interconnect module 10. The electrical connection can be established by inserting the interconnect module 10 in a substantially downward or mating transverse direction into the ring socket 16, the host substrate 20, or both. Contact forces between one or more of the electrically conductive module contacts 24 of the interconnect module 10 and respective, corresponding one or more of the ring electrical contacts 26 of the ring socket 16 may be substantially normal to the mating direction 25 between the interconnect module 10 and ring socket 16, such as in the illustrated lateral direction A. The downward direction is defined in FIG. 1A as a direction perpendicular to and towards host substrate 20 at the major surface 21 without first travelling through an opposed major surface that is opposite the major surface 21.

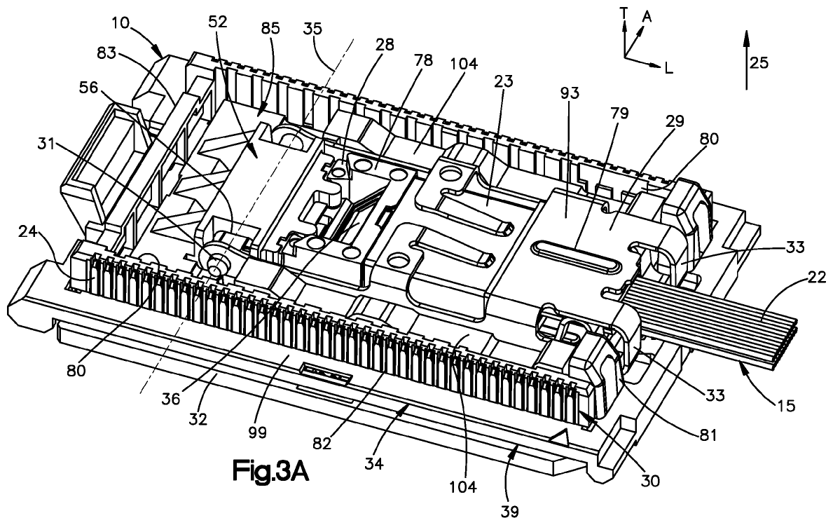

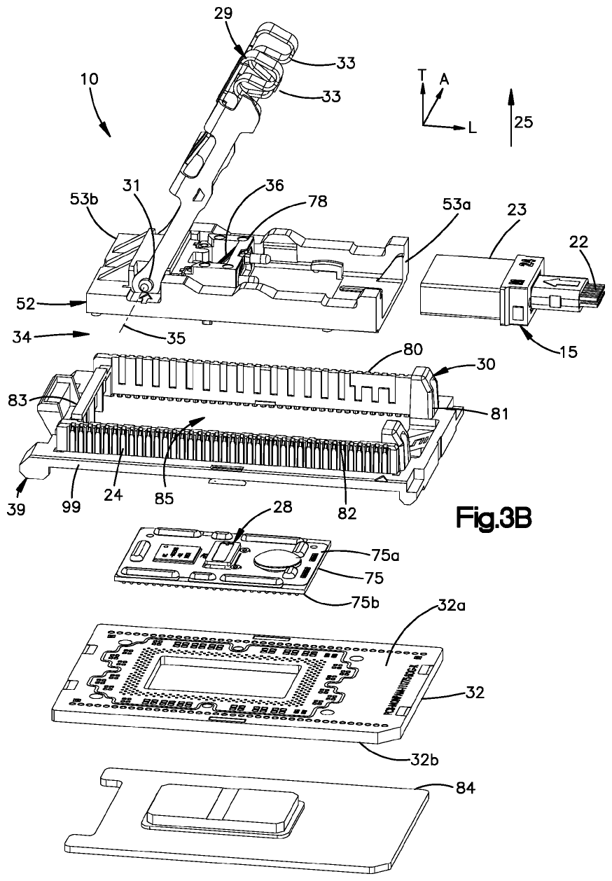

When the interconnect module 10 is an optical transceiver, transmitter, or receiver, the cable 22 can include at least one optical waveguide, such as an optical fiber or a plurality of optical fibers, which terminate in a cable ferrule 23 (see FIGS. 3A-3B). The cable 22 may be arranged as one or more fiber ribbon cables, such as two fiber ribbon cables as depicted in FIG. 1A. It should therefore be appreciated that the cables 22 can be in data communication with the module electrical contacts 24, such that signals in the form of electrical signals from the contacts 24 can be converted to optical signals that are routed along the cables 22. Conversely signals in the form of optical signals received from the cables 22 can be converted to signals in the form of electrical signals that are routed to the module electrical contacts 24. If interconnect module 10 is an electrical interconnect module, the cable 22 can include at least one electrically conductive wire. In some embodiments, the cable 22 attached to the interconnect module 10 may include both an optical waveguide, that can be an optical fiber, and an electrically conductive wire. The waveguide(s) can be permanently attached to the interconnect module 10 or arranged to mate to the interconnect module through a cable ferrule 23, which may be part of an optical connector. The optical connector can be an MT, MPO, LC, SC connector or other type of connectors. The optical connector will typically include a ferrule, such as an MT ferrule in a MT optical connector. The MT ferrule registers end faces of a plurality of optical fibers relative to two precision holes or dowels that are in or supported by the MT ferrule.

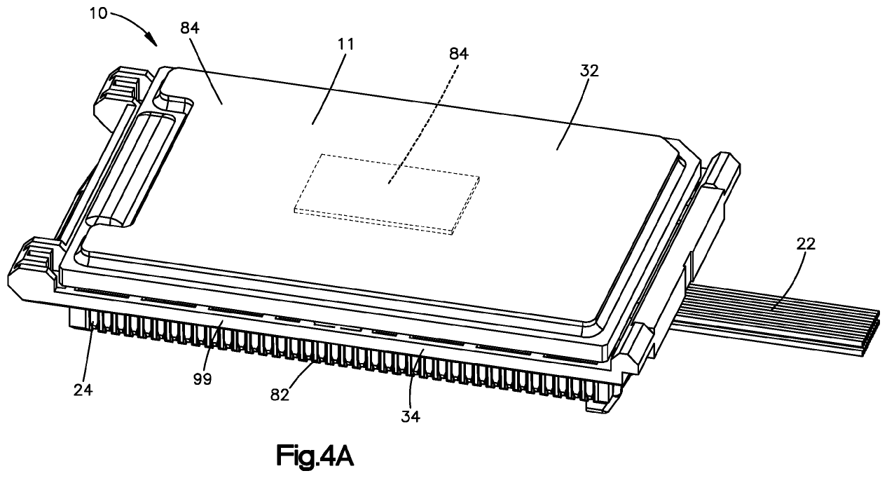

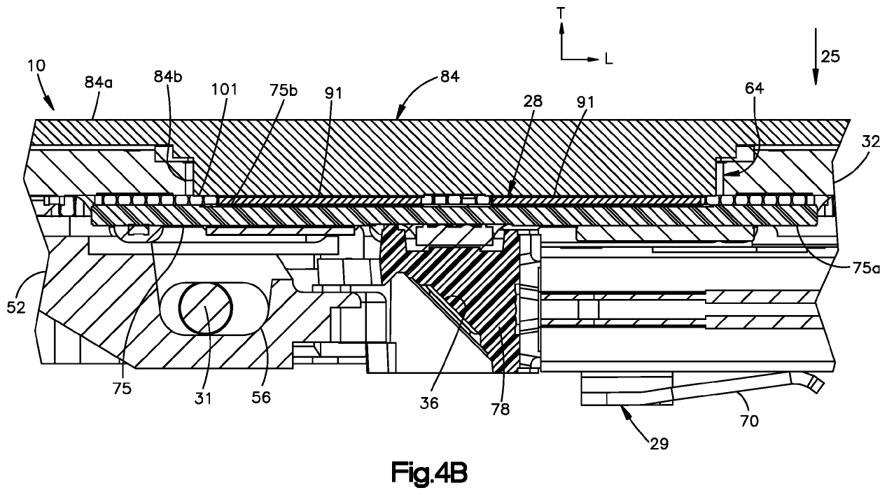

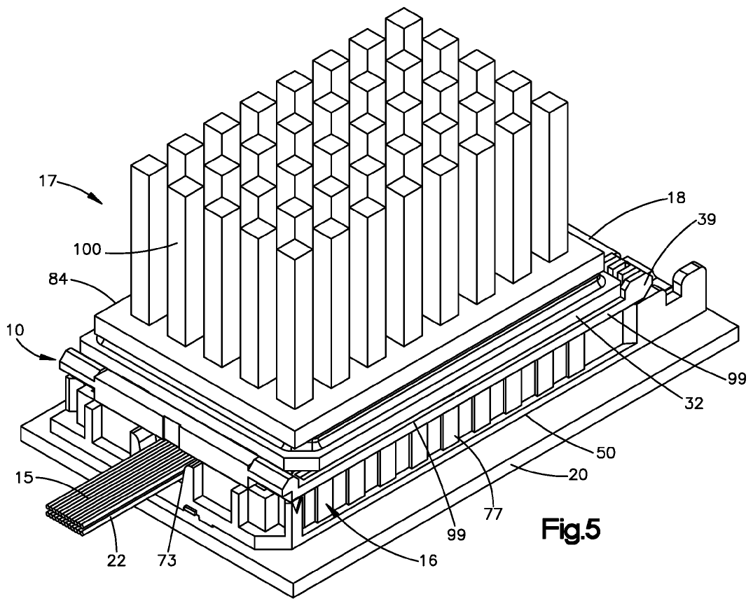

Referring now to FIGS. 2A-2B, the interconnect module 10 is shown mated with the ring socket 16, with the ring socket latch 18 disposed in the locked position, thereby securing the interconnect module 10 into the ring socket 16 and preventing removal of the interconnect module 10 from the ring socket in the unmate direction. The cable 22 can extend out from the ring socket 16 at the first ring socket end 72 of the ring socket 16 opposite the ring socket latch 18 so that the cable 22 and ring socket latch 18 do not mechanically interfere with each other. Advantageously no portion of the ring socket latch 18 extends above a top surface 11 of the interconnect module 10. The top surface 11 can face away from a bottom surface of the interconnect module that faces the host substrate 20 when the interconnect module 10 is mated with the ring socket 16. Because no portion of the ring socket latch 18 extends above the top surface 11, a heat transfer assembly such as a heat spreader 84 (FIG. 4) or a heat sink 100 (FIG. 5) can contact the top surface 11 without any mechanical interference with the ring socket latch 18. The ring socket latch 18 may be slid to its accept position, locked position, and eject position when the heat spreader 84 is installed on the top surface 11 of the interconnect module 10. Also, the ring socket latch 18 does not extend in the lateral direction A past the ring socket sides 76 and 77 (see FIG. 1B) of the ring socket 16. Advantageously, this minimizes a footprint of the ring socket 16 on the host substrate 20 allowing more space for additional components on the host substrate 20.

As shown in FIG. 2A, the ring socket housing 50 can include extensions 61 that extend longitudinally out from the first ring socket end 72. The extensions 61 can be continuous extensions of the ring socket sides 76-77, and can extend a distance so as to be aligned with the latch actuator 19 along the lateral direction A at all positions of the latch actuator 19. The extensions 61 can further extend above the latch actuator 19 in the upward direction. Thus, extensions 61 can be aligned with an entirety of the latch actuator 19 at all positions of the latch actuator 19. During operation, the extensions 61 can protect the latch actuator 19 from inadvertent contact. It should be appreciated in other examples, that the extensions 61 can extend from the first ring socket end 72 to be aligned with the latch actuator 19 in the accept position and the locked position, but not in the eject position. Further, the ring socket housing 50 can define a base that extends between the extensions 61 and defines a guide member 67 that is configured to guide the ring socket latch 18 to slide to its accept, locked, and eject positions during operation. The guide member 67 can include at least one guide channel 69 such as a pair of guide channels 69 that are elongate along the longitudinal direction L, and are spaced from each other along the lateral direction A. The ring socket latch 18 can include complementary guide members 65 that engage the guide members 67 of the ring socket 16, and ride along the guide members 67 during movement of the ring socket latch 18 during use. In other examples, the guide members 65 of the ring socket latch 18 can be configured as channels, and the guide members 67 of the ring socket 16 can be configured as projections that ride in the channels. It should be appreciated that the guide members 65 and 67 can be configured in any suitable alternative manner as desired.

Referring now to FIG. 2C, in still other examples, the ring socket 16 can be devoid of the extensions 61, and can further be devoid of the guide members 65 and 67. Instead, the latch actuator 19 can be seated on a pedestal 63 that extends from the first ring socket end 72 in the rearward direction, and is oriented along a plane that is orthogonal to the transverse direction T. The latch actuator 19 can ride along the pedestal 63 as it travels to each of the accept position, the locked position, and the eject position. The pedestal 63 has a thickness along the transverse direction T, such that movement of the latch actuator 19 along the pedestal 63 is in the longitudinal direction L.

Referring to FIGS. 3A-3B, the interconnect module 10 can include the module substrate 32, the module body 39, the module electrical contacts 24 supported by the module body 39, an electrically insulative module frame 52, an optical engine 28, and a cable latch 29. The optical engine 28, can include electro-optic conversion elements and ancillary electronic components mounted on an engine substrate 75. The engine substrate 75 can be oriented parallel to the module substrate 32 and the host substrate 20. The optical engine 28 can further include an optical block 78 that can be fixedly supported by the module frame 52. Alternatively, the optical block 78 can be fixedly supported by the engine substrate 75. As described in more detail below, the engine substrate 75 can be optically transparent substrate such as a glass substrate. The engine substrate 75 has a first major surface 75a and a second major surface 75b opposite the first major surface 75a along the transverse direction T. The first major surface 75a can face away from the module substrate 32, and the second major surface 75b can face toward the module substrate 32. The opto-electric conversion elements and ancillary electronic components can be mounted on the first major surface 75a of the engine substrate 75. The second major surface 75b of the engine substrate 75 can be mounted to a first major surface 32a of the module substrate 32 so as to place the module substrate 32 in electrical communication with the engine substrate 75.

During operation, when the interconnect module functions as a receiver, the optical engine 28 receives optical signals from optical fibers of the cables 22, and converts the optical signals to electrical signals. The electrical signals are routed through the engine substrate 75 and the module substrate 32 to the module electrical contacts 24. When the interconnect module functions as a transmitter, received electrical signals travel from the module electrical contacts 24 to the module substrate 32, which routes the electrical signals to the engine substrate 75. The optical engine 28 convers the electrical signals to optical signals, which are then transmitted along optical fibers of the cables 22.

The opto-electric components of the interconnect module 10 may include optical engine components including one or more electrical-to-optical conversion elements, such as a vertical cavity surface emitting laser (VCSEL) or a photonic integrated circuit, one or more optical-to-electrical conversion elements, such as a photodiode, a driver for the electrical-to-optical conversion element, a transimpedance amplifier for the photodiode, passive components, such as inductors, resistors, and capacitors, and a controller. The optical block 78 can provide optical coupling between the optical fibers disposed in the cable ferrule 23 and the electro-optical elements of the optical engine components. In some embodiments, the optical block 78 may include a scratch resistant window situated on a face of the optical block 78 facing the cable ferrule 23. The optical block 78 may also be described as a ferrule mate since it is configured to mate with the cable ferrule 23. An interconnect module cable assembly can be defined when the cable ferrule 23 is mated with the interconnect module.

The optical engine 28, and in particular the optical block 78, can define a TIR (total internal reflection) surface 36 of the optical block 78. When the interconnect module 10 functions as a receiver, the total internal reflection surface 36 can reflect optical signals received from the cables to photodetectors, either directly or through intervening optical elements. The photodetectors convert the optical signals to electrical signals that can be sent to a transimpedance amplifier (TIA) of the interconnect module 10. Alternatively, when the interconnect module 10 functions as a transmitter, the optical signals emitted by a laser such as a VCSEL can reflect off the TIR surface 36 to the cables, either directly or via intervening optical elements. The TIR surface 36 can be an optically reflective material having an optically reflective surface such as glass or plastic. In one example, the TIR surface can be defined by a plating of reflective material. The TIR surface 36 can be scuffed, ablated, textured, or otherwise attenuated as disclosed in U.S. Pat. No. 10,884,198 to reduce the intensity of the reflected light. U.S. Pat. No. 10,884,198 is hereby incorporated by reference as if set forth in its entirety herein for all purposes.

The module body 39 and the module frame 52 can combine to define a module housing 34. In this regard, components of the module frame 52 can also be considered to be part of the module housing 34. Similarly, components of the module body 39 can be considered to be part of the module housing 34. Thus, as one example, the module electrical contacts 24 can be said to be supported by the module housing 34. Otherwise stated, components of the module housing 34 can be components of the module body 39 and/or the module frame 52. Thus, reference to the module housing 34 can be made with respect to the module body 39, the frame 52, or both the module body 39 and the module frame 52. The module frame 52 can be disposed inside the module body 39 with respect to a plane that is defined by the longitudinal direction L and the lateral direction A. Otherwise stated, the module body 39 can surround or circumscribe the module frame 52 with respect to each of the longitudinal direction L and the lateral direction A. While the module body 39 carries the electrical contacts 24, the frame 52 does not carry any electrical components in some examples. The module frame 52 can extend out with respect to the module body 39 along the transverse direction T, and in particular in the unmate direction. The module frame 52 can support the cable latch 29 as described in more detail below.

The module housing 34, including the module body 39 and the module frame 52, can be supported by the module substrate 32. In particular, the module housing 34 can be mounted to the module substrate 32, and in particular to the first major surface 32a, such that the module housing 34 extends from the module substrate 32 along the transverse direction T. The module housing 34 can extend from the module substrate 32 in the mating direction 25. The module electrical contacts 24 can similarly be mounted to the first major surface 32a of the module substrate 32. In other examples, the engine substrate 75 and the module substrate 32 can be combined to define a single substrate to which the opto-electrical components, the module housing 34, and the module electrical contacts 24 are mounted.

The module body 39 and the module frame 52 can define a unitary monolithic structure in one example. In this regard, module the module body 39 can be mounted to the module substrate 32, for instance to the first major surface 32a, which thereby causes the module frame 52 to also be mounted to the module substrate 32. Alternatively, the module frame 52 can be mounted to the module substrate 32, for instance to the first major surface 32a, which thereby causes the module body 39 to also be mounted to the module substrate 32. In still other examples, each of the module body 39 and the module frame 52 can be mounted to the module substrate 32, for instance to the first major surface 32a. For instance, the module body 39 and the module frame 52 can define separate structures as desired.

The cable latch 29 may rotate about a pivot axis 35 between an open position (FIG. 3A) and a closed position (FIG. 3B). The pivot axis 35 can be defined by a pivot member, such as a pivot axle 31, that is supported by the module frame 52. For instance, the pivot axle 31 can be captured in a frame slot 56 of the module frame 52 so as to be guided to translate along the longitudinal direction L. The frame slot 56 can prevent the pivot axle 31 from translating along the transverse direction T. The cable latch 29 is attached to the pivot axle 31 and translatably fixed to the pivot axle 31, such that the cable latch 29 is not able to translate relative to the pivot axle 31. Thus, it can be said that the cable latch 29 is pivotally supported by the module housing 34, and in particular by the module frame 52. Further, it can be said that the module housing 34, and in particular the module frame 52, guides the cable latch 29 to translate along the longitudinal direction L while preventing the cable latch 29 from translating along the transverse direction T. The longitudinal direction L is parallel to the major surface of the module substrate 32 to which the interconnect module 32 is mounted. Thus, it should be appreciated that the pivot axle 31 can be permanently supported by the module frame 52, and the cable latch 29 can be permanently attached to the pivot axle 31. Accordingly, the cable latch 29 can be permanently supported by the module housing 34. A component that is permanently supported by another component cannot be removed from each other without damage to at least one or both of the components. The frame slot 56 can be elongate along the longitudinal direction L. Thus, the pivot axle 31 can move in the longitudinal direction L within the frame slot 56. For instance, the pivot axle 31 can move selectively in the longitudinally forward direction and the longitudinally rearward direction in the slot 56. Accordingly, the pivot axis 35 of the cable latch 29 can correspondingly move along the longitudinal direction L, and in particular can move selectively in the forward and rearward directions. The pivot axis 35 can be oriented along the lateral direction A.

The cable latch 29 can retain the cable ferrule 23 in place against the optical block 78 when the cable assembly 15 is inserted in the interconnect module 10 in the insertion direction, and the cable latch 29 is moved to its closed position shown in FIG. 3A. The cable latch 29 can include at least one compression member 33 on an opposite side of the cable latch 29 from the pivot axis 35. For instance, the cable latch 29 can include first and second compression members 33. Each compression member 33 may apply a force to the cable ferrule 23 in the insertion direction of the cable ferrule 23 that biases the cable ferrule 23 against the optical block 78. The cable latch 29 can further define a grip 79 that can be engaged by a user's finger(s) when driving the cable latch 29 to its closed position. The grip 79, for instance, can be defined by an embossment of a cable latch cover 93 that is described in more detail below.

With continuing reference to FIGS. 3A-3B, the module body 39, and thus the module housing 34, can include a base 99, and sides and ends that extend out along the mating direction with respect to the base 99. The sides and ends can also extend out a greater extent than the frame 52. The sides can include a first module side 80 and a second opposed module side 82 that is opposite the first module side 80 along the lateral direction A. The ends can include a first or front module end 81 and a second or rear module end 83 that are opposite each other along the longitudinal direction L. The sides 80 and 82 and the ends 81 and 83 can extend from the base 99 in the transverse direction T, and in particular in the mating direction 25. The module sides 80 and 82 can extend between the first and second module ends 81 and 83, respectively. For instance, the module sides 80 and 82 can extend from the first module end 81 to the second module end 83 so as to define an outer frame 30. The frame 52 can be referred to as an inner frame. The base 99 can surround or circumscribe the outer frame 30, including each of the module sides 80 and 82 and the module ends 81 and 83.

The module sides 80 and 82 can each extend a first distance along the longitudinal direction L, and the module ends 81 and 83 can each extend a second distance along the lateral direction A. The second distance can be less than the first distance. The module sides 80 and 82 and module ends 81 and 83 can cooperate to define an internal module void 85 that contains the frame 52, the optical block 78, and the cable latch 29, in addition to other optical, mechanical, and electrical components of the interconnect module 10. The first direction or forward direction can extend in the longitudinal direction L from the second module end 83 toward the first module end 81. The second direction or rearward direction can extend in the longitudinal direction L from the second module end 83 toward the first module end 81. The insertion direction of the cable assembly 15 into the interconnect module 10 can be defined by the second direction. A front end of the outer frame 30 can thus be defined by the first module end 81, and a rear end of the outer frame 30 can be defined by the second module end 83. The module frame 52 similarly can define a front end 53a that faces the first module end 81 of the module body 39, and an opposed rear end 53b that faces the second module end 83 of the module body 39.

The module electrical contacts 24 can be supported by the module housing 34, and in particular can be supported by the module body 39. Alternatively, the module electrical contacts 24 may be supported by a body that is separate from the module body 39. The module electrical contacts 24 can be arranged in respective rows along the first and second module sides 80 and 82. Thus, the first and second module sides 80 and 82 can each carry respective rows of the module electrical contacts 24. The module electrical contacts 24 can be constructed substantially identical (i.e., within manufacturing tolerance) to each other. Each of the respective rows of module electrical contacts 24 can be oriented parallel to each other. For instance, the rows can be arranged along respective linear arrays that extend along the longitudinal direction L. When the interconnect module functions as a receiver, the optical engine 28 receives optical signals from the cables 22, and converts the optical signals to electrical signals. The electrical signals are routed outward along the lateral direction A (i.e., from electrical traces of the engine substrate 75 to electrical traces of the module substrate 32) to respective ones of the module electrical contacts 24 at the first and second rows. When the interconnect module functions as a transmitter, the electrical signals are received at the module electrical contacts 24, and are routed laterally inward by electrical traces of the module substrate 32 and electrical traces of the engine substrate 75 to the optical engine. The electrical signals are then converted to optical signals that are transmitted out the interconnect module 10 along the optical fibers defined by the cables 22. The module substrate 32 may have a rectangular shape on its outer sides with respect to the longitudinal direction L and the lateral direction A.

The module electrical contacts 24 can define mating ends that face away from the internal void 85, and thus face toward the mating ends of the ring electrical contacts 26 when the interconnect module 10 is mated to the ring socket 16 (see FIG. 1A). The module electrical contacts 24 can be supported by each of the first and second module sides 80 and 82. The interconnect module can be devoid of module electrical contacts 24 along the first and second module ends 81 and 83. Thus, it can be said that the module electrical contacts 24 can be arranged along the two long sides of the interconnect module 10. Accordingly, first and second rows of the module electrical contacts 24 can be supported by the first and second module sides 80 and 82, respectively. The module electrical contacts 24 can be arranged to have a uniform pitch between adjacent contacts. It should be appreciated that, in one example, all rows of module electrical contacts 24 can be retained by a single body, which can be defined by the module body 39. Alternatively, the module housing 34 can include at least first and second bodies that support respectively the first and second rows of module electrical contacts 24. Each of the first and second bodies can be linked together by at least one interconnect module mechanical link member, which can be disposed at one or both of the respective longitudinal ends of the module housing 34 or any suitable alternative location. When the interconnect module 10 is mated with the ring socket 16, the module electrical contacts 24 at the first side 80 of the interconnect module 10 mate with ring electrical contacts 26 at the first side 76 of the ring socket 16, and the module electrical contacts 24 at the second side 82 of the interconnect module 10 mate with ring electrical contacts 26 at the second side 77 of the ring socket 16 (see FIG. 1A).

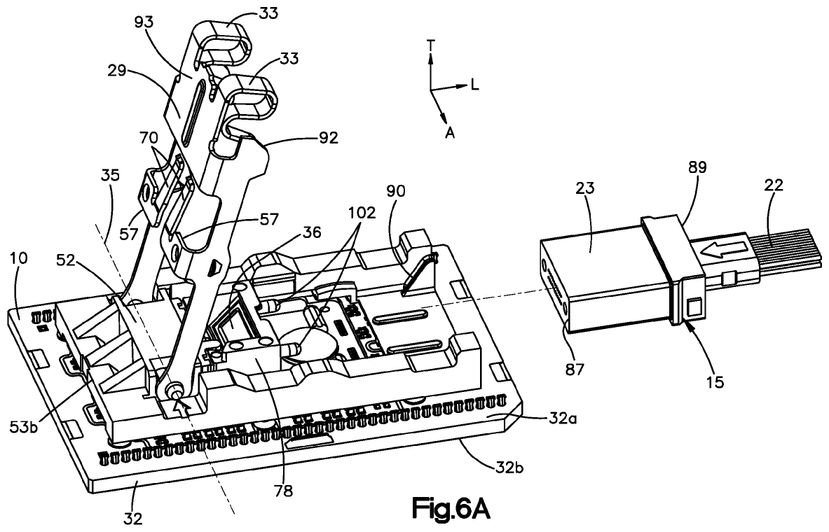

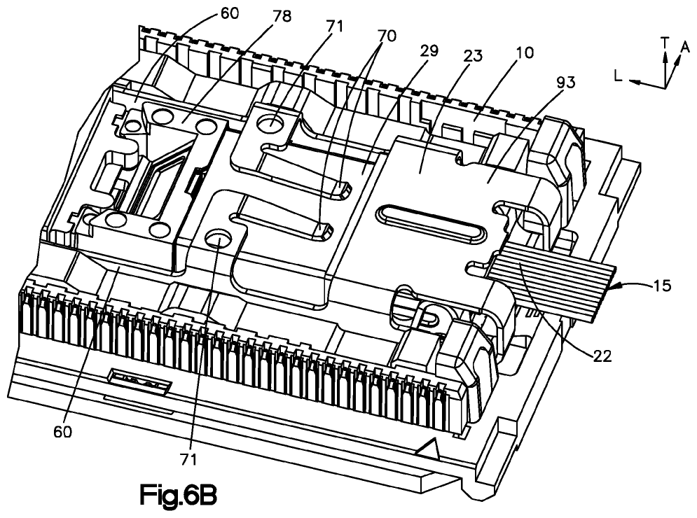

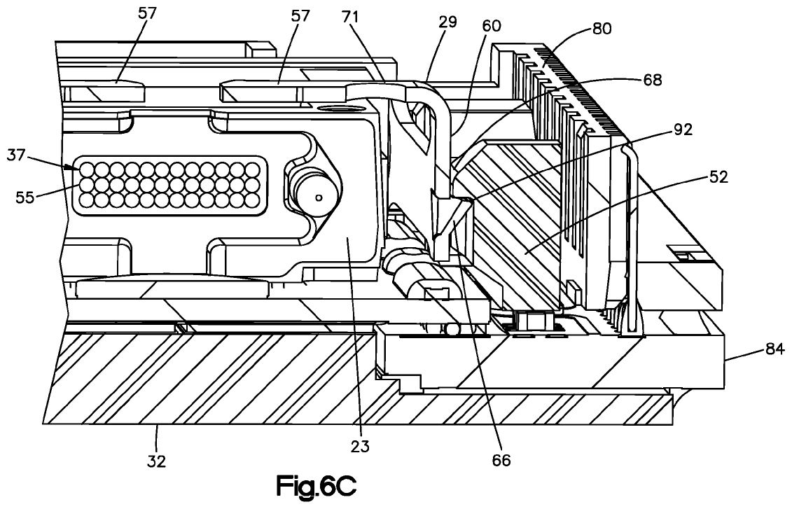

As described above, the interconnect module 10 may include an optical engine 28, which can include the optical block 78 as well as the various electrooptic conversion elements and ancillary electronic components mounted on the engine substrate 75 as described above. The optical engine 28 can be disposed in the internal module void 85. The optical block 78 can couple light between the optical components, such as VCSELs, and photodetectors, and optical waveguides or optical fibers in the cable 22. The optical block 78 can also perform other functions like redirecting a portion of the light into an optical power measurement system or attenuating light emitted by a light source, such as a VCSEL. In some embodiments the optical engine 28 may include other components, such as a modulator, wavelength filters, such as used in WDM applications, isolators for transmission path, and monitor photodiodes to monitor transmit power. Further, as shown in FIG. 6C, the optical engine 28 can include an array 37 of lenses 55 that can receive optical signals from the optical fibers and collimate the optical signals when the interconnect module 10 is an optical receiver, and can receive optical signals and collimate the optical signals that travel along the optical fibers to an external component when the interconnect module 10 is an optical transmitter. The lens array 37 can have cleats that are received in a complementary apertures of the interconnect module substrate 32 or other structure to align the lenses 55 are aligned with the photodiodes and/or VCSELS and the respective ones of the optical fibers of the cables 22. The optical engine 28 may have parallel channels that transmit and/or receive high-speed data signals. The optical engine 28 can be positioned substantially between the two rows of module electrical contacts 24 of the interconnect module 10. The rows of module electrical contacts 24 can be substantially side by side when seen in the longitudinal direction L parallel to the major surface 21 of the host substrate 20 when the interconnect module 10 is mated to the ring socket 16 (see FIGS. 2A-2B).

With continuing reference to FIGS. 3A-3B, the module body 39 can perform several functions. For instance, the module body 39 can retain the module electrical contacts 24 of each row of the interconnect module 10. The module body 39 can also provide a mechanical link to position and hold each row of module electrical contacts 24 relative to each other. The module body 39 can also provide an enclosure that defines the module internal void 85 to protect or to seal the optical engine 28 from the environment, and provide mechanical support for the cable 22. The module body 39 can also provide a pass through for the cables 22 that extend through the cable ferrule 23 along the longitudinal direction L and out the interconnect module body 39 at a location spaced from the second end 83 along the transverse direction T. For instance, the module body 39 can define the gap 73 that extends through the first end 81 along the longitudinal direction L that is sized such that the cables 22 can extend through the gap 73 when the cable assembly 15 is mated to the interconnect module 10.

The engine substrate 75 can be an organic substrate (epoxy glass, polyimide, etc.), a glass substrate, or a ceramic substrate (BeO, AlN, Al₂O₃ or LTCC (low temperature co-fire ceramic, etc.). Each substrate material may be formed with a number of layers bonded together along the transverse direction T with electrically conductive traces on surfaces of some up to all of the layers. Electrically conductive vias may electrically connect electrical traces on different layers along the transverse direction T. Each substrate material has pros and cons. Both ceramic and organic substrates can be well suited to route power, low and high-speed signals, and support vias. Surface mount components like electrical connector leads, chip capacitors and resistors, microchip packages (BGA (ball grid array), etc.) and bare die chips can be soldered, flip-chip mounted and/or wire bonded to the module substrate 32. Alternatively, bare die chips can also be epoxied to any substrate material and wire bonded.

Advantages of an organic substrate include low cost and a closer match of the coefficient of thermal expansion to metals and polymers. Metal risers and stiffeners can be soldered to or otherwise attached to the engine substrate 75 to provide mounting surfaces, spacers or to increase rigidity of the assembly. Organic substrates can have more complex perimeters or outlines than ceramic or glass substrates and allow more easily fabricated through holes. Potential disadvantages of an organic substrate may be difficulties in supporting cavities and pockets, although small components can be embedded in them in certain cases. Organic substrates may also have higher loss for transmitted electrical signals, particularly at high frequencies.

Advantages of a ceramic substrate are generally increased rigidity (higher Young modulus), flatness, and high thermal conductivity. They readily support cavities and pockets and can support wrap around and sidewall metallization. Their coefficient of thermal expansion is a better match to Si and III-V materials, but dimensional tolerances may be hard to control due to batch-to-batch shrinkage variation during the firing process. Glass substrates have desirable dielectric properties allowing transmission of high-speed signals with good signal integrity. In some embodiments, the different layers of the substrate may be formed from different materials.

Referring to FIGS. 4A-4B, the interconnect module 10 can include a heat spreader 84 that, in turn, can define at least a portion of the top surface 11 of the interconnect module 10. In one example, the module substrate 32 can define a hole 64 that extends therethrough along the transverse direction T. The heat spreader 84 can be configured as a plate 84a having an extension 84b may be positioned in the hole 64. For instance, the hole 64 can be stepped, and the extension 84b can be stepped so as to nest in the hole 64. The heat spreader 84, such as the extension 84b, can contact a heat generating electro-optical element 91 of the optical engine 28 so as to dissipate heat along a thermally conductive path along the transverse direction T out the interconnect module 10. In particular the thermally conductive path can extend in the unmate direction. The heat generating element 91 can be mounted to the engine substrate 75, and in particular to the second surface 75b of the engine substrate 75. In one example, the heat generating element 91 can be configured as at least one integrated circuit (IC), such as a pair of application specific integrated circuits (ASICs). Various electronic and electro-optical components may be in thermal contact with an inboard side (for instance, the side that faces the mating direction) of the heat spreader 84. These electrical and electro-optical components may include a photodetector and associated TIA, a light source and associated light source driver, and a microcontroller.

As shown in FIG. 4B, each of the second surface 75b of the engine substrate 75 and the module substrate 32 can be spaced from the module substrate 32 along the transverse direction T so as to define a gap 101 therebetween. In some examples, the module substrate 32 can include holes extending therethrough along the transverse direction T that are aligned with the gap 101 so as to provide an air vent that allows hot air to escape from the interconnect module 10 during operation. Similarly, the heat spreader 84 can include holes extending therethrough along the transverse direction T that are aligned with the gap 101 so as to provide an air vent that allows hot air to escape from the interconnect module 10 during operation. The holes of the heat spreader 84 can be metalized in some examples. It should be recognized that components of the interconnect module 10 can be sealed so as to prevent unwanted debris from entering the interconnect module 10. Any suitable sealant can be used, such as epoxy. For instance, the heat spreader 84 can be sealed to the module substrate 32. Other elements of the optical engine 28 can be sealed to the frame 52. For instance, one or more surfaces of the optical block 78 can be sealed to the frame 52. Further, epoxy can be disposed between the frame 52 and a surface of the optical block 78 that is opposite the surface of the optical block that mates with the cable ferrule 23 along the longitudinal direction L. The epoxy can extend along an entirety of the surface of the optical block 78.

Referring now to FIG. 5, a heat sink 100 can be installed onto the interconnect module 100. In some examples, the heat sink 100 can be a zipper heat sink or any suitable alternative heat sink. In one example, the heat sink 100 can be in thermal communication, and in one example physical contact, with the top surface defined by the heat spreader 84. Thus, the heat spreader 84 can provide a direct, low thermal impedance path, to the heat sink 100 which may be mounted to an outboard surface or top surface 11 of the heat spreader. A thermal heat dissipation path can thus be directed in the upward unmate direction along the transverse direction T, away from the substrate 32. In particular, the heat spreader 84 and/or heat sink 100 can direct heat away from the substrate 32 in a direction opposite the surface of the substrate 32 to which the interconnect module housing 34 and module electrical contacts 24 are mounted.

The heat sink 100 can define a plurality of fins as desired. The heat sink 100 may be arranged so that the latch actuator 19 is accessible. This allows the ring socket latch 18 to be moved selectively into its accept, locked, and eject positions without mechanical interference between the latch 18 and the heat sink 100 installed on the interconnect module 10. Thus, the interconnect module 10 can mate with and unmate from the ring socket 16 without removing the heat sink 100 or the heat spreader 84.

Referring now to FIGS. 3A-B and 6A-C, and as described above, The cable latch 29 can hinge or rotate about the pivot axis 35 between a closed position shown in FIGS. 3A and 6B-C to an open position shown in FIGS. 3B and 6A. In the closed position, the cable latch 29 secures the cable ferrule 23 of a cable assembly 15 mated to the interconnect module 10. In particular, the cable latch 29 secures the cable ferrule 23 to the optical block 78. An interconnect module cable assembly is thus defined when the cable assembly 15 is mated to the interconnect module 10. The cable latch 29 can extend in the first or forward direction from the pivot axle 31 when the cable latch 29 is in the closed position. The cable ferrule 23 can retain portions of the cables 22, such as ends of the cables 22. Thus, it can be said that the cables 22 terminate in the cable ferrule 23. The cable ferrule 23 can define a first or leading face 87 with respect to the insertion direction of the cable ferrule 23 into the interconnect module 10, and a second or trailing face 89 opposite the leading face 87. The cable latch 29 can maintain the leading face 87 in abutment with the optical block 78, such that the cables 22 and the optical block 78 are optically aligned with each other. The cable ferrule 23 may be a MT (multifiber termination) ferrule or some other ferrule supporting optical fibers that is part of an optical interconnection system between the cables 22 and the optical block 78.

The cable ferrule 23, and thus the cable assembly 15, is inserted into the interconnect module in insertion direction, which can be defined by the longitudinal direction L, and in particular the longitudinally rearward direction described above. Thus, the insertion direction of the cable ferrule 23 can be substantially parallel to the major surface of the module substrate 32 to which the module housing 34 and optical engine 28 are mounted. The insertion direction of the cable ferrule 23 can also therefore be substantially parallel to the major surfaces 75a and 75b of the engine substrate 75. The leading face 87 of the cable ferrule 23 can be urged against the optical block 78 by a longitudinal compression force applied by the cable latch 29 when the cable latch 29 is in the closed position. In particular, the force from the cable latch 29 can be provided by elastic deformation of one or more compression members 33, such as a pair of compression members shown in FIGS. 3A-3B. In one example, the compression members 33 can be configured to cumulatively apply a longitudinal compression force of in a range from 500 grams to 3000 grams. For instance, the longitudinal compression force can be in the range from 1000 grams to 2000 grams. In one specific example, the longitudinal compression force can be 1200 grams approximately (i.e., including 1200 grams up to plus or minus 10% of 1200 grams). Each compression member 33 can apply half the longitudinal compression force. The cable latch 29 may thus provide a sufficient force to the ferrule 23 that ensures mechanical contact between the end faces of the optical fibers in the cable 22 and the optical block 78. One of the optical block 78 and the cable ferrule 23 can define alignment pins 102 that are received in the other of the optical block 78 and the cable ferrule 23 to achieve mechanical registration between the optical block 78 and the cable ferrule 23 as the cable assembly 15 is inserted into the interconnect module 10 in the insertion direction.

As shown in FIG. 6A when the cable latch 29 in the open position, and the cable latch 29 is positioned such that the interconnect module 10 is configured to accept or release a detachable cable assembly 15. The cable assembly 15 may be defined by the cable 22 and the cable ferrule 23. The cable ferrule 23 terminates one end of the cable at the leading face 87, supporting end faces of the optical fibers that reside in the cable 22 that are exposed at the leading face 87. The cable latch 29 may be carried by the module frame 52 or some other structure of the interconnect module 10. The cable latch 29 can be arranged so that it is permanently connected to the rest of the interconnect module 10.

To attach the cable assembly 15 to the interconnect module 10, the cable assembly 15 is inserted in a first or insertion direction, which can be defined by the longitudinally rearward direction, toward the optical block 78 until the leading face 87 of the cable ferrule 23 is disposed adjacent the optical block 78. For instance, the cable ferrule 23 can contact the optical block 78. The cable latch 29 may then be rotated downward in a first direction of rotation about the pivot axis 35 to the closed position that secures the cable ferrule 23 against the optical block 78. The pivot axis 35 is oriented perpendicular to the insertion direction of the cable ferrule 23. Further, both the pivot axis 35 and the insertion direction of the cable ferrule 23 can be parallel to the major surface of the module substrate 32 to which the interconnect module 10 is mounted. The module frame 52 can include at least one inclined surface 90 that the cable latch 29 engages as it moves to the closed position. For instance, the module frame 52 can include first and second inclined surfaces 90 that are opposite each other along the lateral direction A. The inclined surfaces 90 can be symmetrically arranged about a bisecting plane that is defined by the longitudinal direction L and the transverse direction T.

To remove the cable assembly 15 from the interconnect module 10, the cable latch 29 can be rotated in a second direction of rotation about the pivot axis 35 from the closed position to the open position, and the cable assembly 15 can be removed from the interconnect module along a second or removal direction that is opposite the insertion direction. When the cable latch 29 is in the open position, the cable latch 29 is free from interference with the cable assembly 15.

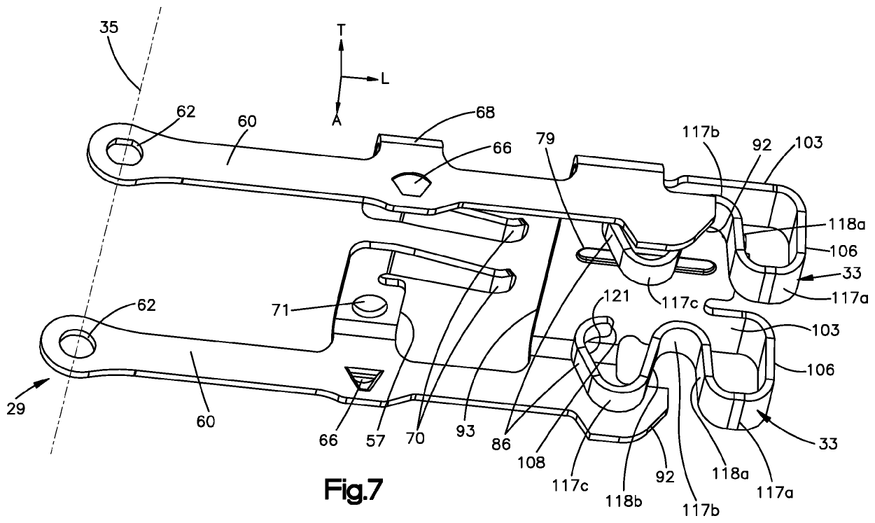

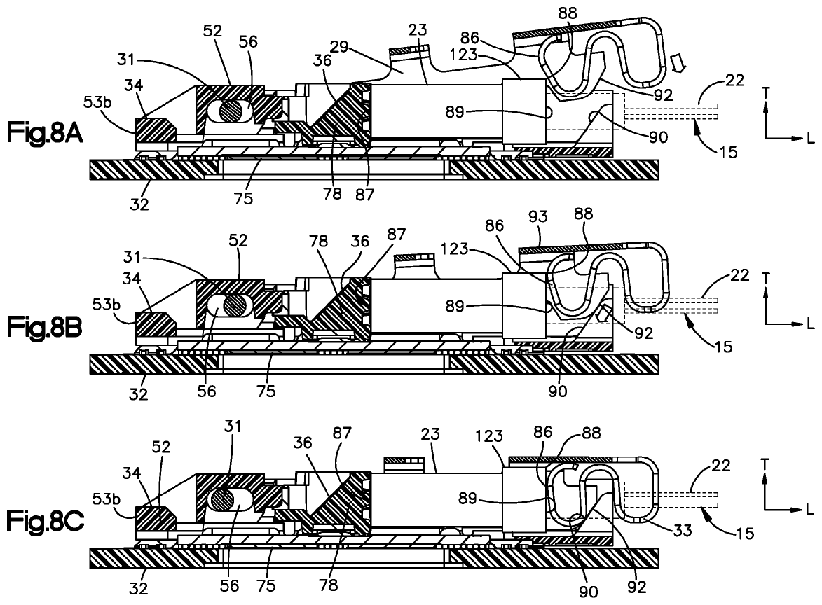

The cable latch 29 will now be described with additional reference to FIGS. 7-8C. As shown, the cable latch 29 can include first and second cable latch arms 60 that are elongate along the longitudinal direction L and opposite each other along the lateral direction A. The cable latch arms 60, and the cable latch 29, may be symmetric about a bisecting plane that is defined by the longitudinal direction L and the transverse direction T.

The cable latch 29 defines an inner transverse direction that extends along the transverse direction T toward the module substrate 32, and an outer transverse direction that is opposite the inner transverse direction along the transverse direction T, and thus extends along the transverse direction away from the module substrate 32. The inner transverse direction thus also extends toward a mounting interface of the module housing 34 that is configured to mount to the module substrate 32. The outer transverse direction thus extends away from the mounting interface of the module housing 34 that is configured to mount to the module substrate 32. The outer transverse direction can define the mating direction, and the inner transverse direction can define the unmating direction when the interconnect module 10 is mounted to the ring socket 16 (see FIG. 1A). However it is appreciated that the cable latch 29 can be actuated when the interconnect module 10 is unmated from the ring socket 16, and the interconnect substrate 32 is placed on a support surface. In particular, a second major surface 32b of the interconnect substrate 32 that is opposite the first major surface 32a can be placed on a bottom support surface. Thus, during operation of the cable latch 29 shown in FIGS. 8A-8C when the interconnect module 10 is unmated from the ring socket 16, the inner transverse direction may be a downward direction along the transverse direction T toward the interconnect substrate 32, and the outer transverse direction may be an upward direction away from the interconnect substrate along the transverse direction T. The terms “downward” and “upward” and derivatives thereof as used with respect to the cable latch 29 can apply to the cable latch 29 when the cable latch 29 is in its closed position and the interconnect module 102 is in an orientation that is defined when the second major surface 32b of the module substrate 32 rests against a bottom support surface or base. The upward direction can define the mating direction when the interconnect module 10 is mated with the ring socket 16, and the downward direction can define the unmating direction when the interconnect module 10 is unmated from the ring socket 16. The interconnect module 10 can then be flipped over with respect to the transverse direction T so that it is positioned to be mated with the ring connector 16 in the downward mating direction. The first and second major surfaces 32a and 32b can be defined by the longitudinal direction L and the lateral direction A, and thus can be perpendicular to the transverse direction T.

With continuing reference to FIGS. 7-8C, each cable latch arm 60 can define an attachment member that is configured to attach to the pivot member such as the pivot axle 31. In one example, the attachment member of each cable latch arm 60 can be configured as a pivot hole 62 that is configured to accept the pivot axle 31 as shown in FIG. 3A so as to provide a pivot axis 35 for the cable latch 29. In some examples, the latch arms 60 can pivot about the pivot axle 31. In other examples, the latch arms 60 can be movably coupled to the pivot axle 31 such that the pivot axle 31 rotates as the latch arms 60 pivot. The pivot holes 62 can be disposed adjacent respective longitudinal rearward ends of the latch arms 60. It should be appreciated that the cable latch arms 60 can attach to any suitable alternative pivot member in any suitable alternative manner as desired. For instance, the cable latch arms 60 can define protrusions, and the pivot member can define apertures that accept the protrusions to provide the pivot axis 35.

The cable latch 29 can further include at least one compression member 33 supported by a respective at least one of the cable latch arms 60. The at least one compression member 33 can be spaced from the pivot members of the latch arms 60 in the longitudinally forward direction. The cable latch 29 can include first and second compression members 33 that are supported by the first and second cable latch arms 60, respectively, and spaced from each other along the lateral direction A. The compression members 33 can be elastically compressible along the longitudinal direction L from their natural state. The elastic compression causes the compression members 33 to apply a retention force to the cable ferrule 23 in the insertion direction of the ferrule 23 that urges the cable ferrule 23 against the optical block 78, thereby retaining the cable ferrule 23, and thus the cable assembly 15, in its mated position against the optical block 78 when the cable latch 29 is in the closed position and the cable ferrule 23 is inserted in the interconnect module 10. The cables 22 can extend out the interconnect module 10 along the longitudinal direction L between the compression members 33 with respect to the lateral direction A.

In one example, the cable latch 29 can include a cable latch cover 93 that extends from the first cable latch arm 60 to the second cable latch arm 60. The embossment 79 can be formed in the cable latch cover 93 so as to provide a grip that can be engaged by a user's finger(s) when driving the cable latch 29 to its closed position (see also FIG. 3A). The cable latch 29 can include first and second compression members 33 that extend from the cover 93. Each compression member 33 can extend from the cover 93 to a respective abutment surfaces 86. Thus, each compression member 33 can extend from the cover 93 in the longitudinally rearward direction. Each abutment surface 86 can face the longitudinally rearward direction, and can be positioned to bear against the cable ferrule 23 as described above. In one example, each compression member 33 can terminate at a respective abutment surface 86. Each compression member 33 can be configured as a compression beam having one or more compressible folds that are configured to elastically compress along the longitudinal direction L toward each other so as to apply the longitudinal retention force in the rearward direction to the cable ferrule 23.

The compression member 33 will now be described in its initial or uncompressed state. In one example, each the compression member 33 can be supported by the latch arms 60, and in particular by the cover 93. In one example, each compression member 33 can extend from the cover 93 to a distal end 108. For instance, each compression member can include a support segment 103 that extends from the cover 93 in the forward direction to a rear segment 106 that can extend from the support segment 103 in the downward direction. The rear segment 106 can extend to a first curved segment 117a. In a direction along the compression member 33 from the cover 93 to the distal end 108, the first curved segment 117a can curve downward as it extends from the rear segment 106 in the rearward direction, and then transitions upward as it continues to extend in the rearward direction to a first intermediate segment 118a. The first intermediate segment 118a can extend generally upward from the respective first curved segment 117a. For instance the first intermediate segment 118a can flare away from the rear segment 106 as it extends away from the first curved segment 117a. The first intermediate segment 118a can extend to a second curved segment 117b. In the direction along the compression member 33 from the cover 93 to the distal end 108, the second curved segment 117b can curve in the upward direction as it extends in the rearward direction from the first intermediate segment 118a, and then transitions downward as it continues to extend in the rearward direction to a second intermediate segment 118b. The second intermediate segment 118b can extend generally downward from the second curved segment 117b. For instance, the second intermediate segment 118b can flare away from the first intermediate segment 118a as it extends downward from the second curved segment 117b. The second intermediate segment 118b extends from the second curved segment 117b to a third curved segment 117c. In a direction along the compression member 33 from the cover 93 to the distal end 108, the third curved segment 117c can curve downward as it extends from the rear segment second intermediate segment 118b in the rearward direction, and then transitions upward as it continues to extend in the rearward direction to a front segment 121. The front segment 121 extends generally upward from the third curved segment 117c. For instance, the front segment 121 can flare away from each of the first and second intermediate segments 118a and 118b in the rearward direction as it extends from the third curved segment 117c. The front segments 121 can define the abutment surfaces 86 that are configured to abut the ferrule 23 so as to provide the retention force to the ferrule 23. The front segment 121 extends from the third curved segment 117c to a curved distal tip that defines the distal end 108. The curved distal tip can curve in the forward direction as it extends upward. The distal tip can terminate at the distal end 108, which can define a free end.

The latch arms 60 can extend to a position aligned with the front wall 121, and thus aligned with the abutment surface 86, along the lateral direction. For instance, the latch arms 60 can be aligned with an entirety of each abutment surfaces 86 along the lateral direction A. In this regard, the latch arms 60 can guard against inadvertent contact between a user and the abutment surface 86.

With respect to a view of the compression member 33 in the upward direction, the first curved segment 117a, can define a first convexity. With respect to the view of the compression member 33 in the upward direction, the second curved segment 117b can define a concavity. With respect to the view of the compression member 33 in the upward direction, the third curved segment 117c can define a second convexity. Thus, the concavity can be disposed between the first and second convexities along the longitudinal direction. The first curved segment 117a, the rear segment 106, and the first intermediate segment 108a in combination define a first general U-shape. The second intermediate segment 118b, the third curved segment 117a, and the front segment 121 in combination can define a second U-shape. The first intermediate segment 108a, the second curved segment 117b, and the second intermediate segment 108b in combination define an inverted general U-shape that adjoins the first and second general U-shapes. It should be appreciated that each curved segment 117a-c defines a fold of the compression member 33, such that the folds are spaced from each other along the longitudinal direction L, and are elastically compressible toward each other along the longitudinal direction L. It should further be appreciated that the compression member 33 has alternating convex curved sections and concave curved sections. The compression member 33 can have any suitable number of convexities and concavities as desired. As illustrated, the compression member 33 has a single concavity between first and second convexities. The concavity can be upwardly offset with respect to the convexities. The rear segment 106, the curved segments 117a-117c, the intermediate segments 118a-b, the front segment 121 can generally define a W-shape.

It should be appreciated that the compression members 33 can each be a unitary monolithic structure. Further, the compression members 33 can be monolithic with each other so as to define a unitary structure. Further still, an entirety of the cable latch 29 can define a monolithic unitary structure. For instance, the cable latch can be stamped and formed from a flat sheet of metal. The cable latch 29 can be alternatively constructed in any suitable alternative manner as desired.

Each abutment surface 86 can be angled in the longitudinally rearward direction as it extends in the upward direction. Thus, as described in more detail below, each abutment surface 86 can ride along the cable ferrule 23 to a position so that the abutment surface 86 is adjacent the cable ferrule 23 in the longitudinally forward direction, and applies the retention force described above. Each abutment surface 86 can be aligned with the cover 93 along the transverse direction T. It should be appreciated that the compression members 33 can be supported by the latch arms 60 in any suitable alternative manner as desired.

The cable latch 29 can further include at least one stabilization arm 70 that is supported by at least one cable latch arms 60. For instance, the cable latch 29 can include at least one spacer 57 that extends from each cable latch arm 60 that extends toward the other cable latch arm 60 along the lateral direction A. The at least one spacer 57 can be substantially planar along the longitudinal direction L and the lateral direction A. The at least one stabilization arm 70 can extend from the at least one spacer 57, respectively, in the forward direction. The at least one stabilization arm 70 can be angled downward along the transverse direction T as it extends in the forward direction. In one example, the cable latch 29 can include first and second spacers 57 that extend from the first and second latch arms 60, respectively, along the lateral direction A and terminate along the lateral direction without contacting each other. The stabilization arms 70 can extend from respective laterally inner ends of the spacers 57. Alternatively, the stabilization arms 70 can extend directly from the cable latch arms 60. The stabilization arms 70 can be disposed between the attachment members, such as the pivot holes 62, and the at least one compression member 33 with respect to the longitudinal direction L. The cable latch 29 can define a hole 71 that extends through each of the spacers 57 along the transverse direction T.

The stabilization arms 70 are positioned and configured to bear against the cable ferrule 23 when the cable latch 29 is in the closed position. The at least one stabilization arm 70 is removed from the cable ferrule 23 when the cable latch 29 is in the open position. The stabilization arms 70 can be configured to contact the upper surface of the cable ferrule 23 when the cable ferrule 23 is attached to the interconnect module 10 and the cable latch 29 is in the closed position. The stabilization arms 70 can be elastically deformably in the transverse direction T, and in this regard can be referred to as spring arms that are elastically deformed when they contact the cable ferrule 23. Thus, the arms 70 apply a spring force to the cable ferrule 23 that resists a change in angular orientation of the ferrule. Alternatively, the arms 70 can be substantially rigid and apply a force against the cable ferrule 23 that is not a spring force. The stabilization arms 70 can maintain a constant orientation of the cable ferrule 23 when the cable ferrule 23 it is urged against the optical block 78 by the compression members 33 (see FIGS. 8A-8C). For instance, the stabilization arms 70 can prevent the cable ferrule 23 from twisting along the longitudinal direction L.

The cable latch 29, and in particular each of the latch arms 60, can further include at least one attachment member that, as described below, is configured to releasably attach to the module frame 52 when the cable latch 29 is in the closed position, thereby releasably retaining the cable latch 29 in the closed position. In one example, the attachment member can be configured as a lance 66. Thus, the at least one lance can releasably secure the cable latch 29 in the locked position. As shown, the cable latch 29 can include first and second lances 66 that are spaced from each other along the lateral direction A. For instance, the at least one lance 66 can be defined by at least one cable latch arm 60. Thus, each cable latch arm 60 can define a respective lance 66. The lances 66 can be aligned with the holes 71 in a plane that is defined by the lateral direction A and the transverse direction T.

The cable latch 29 can further include at least one engagement member that is supported by the cable latch arm 60 and configured to be engaged by a cable ejection tool that can remove the engagement between the lances 66 and the module frame 52. The engagement member can be configured as a dimple 68 that extends from a respective one of the cable latch arms 60. In one example, the cable latch 29 can include first and second dimples 68 that are spaced from each other along the lateral direction A. The first and second dimples 68 can extend from the first and second cable latch arms 60. The stabilization arms 70 can extend from the dimples 68. The dimples 68 can be disposed adjacent respective ones of the lances 66, such that a force applied to the dimples 68 can cause the lances 66 to elastically move. In one example, the dimples 68 can be aligned with the lances 66 along the transverse direction T.

The cable latch 29 may include at least one bearing surface configured to engage the module frame so as to drive the cable latch 29 in the longitudinally rearward direction as the cable latch 29 is moved to its locked position (see FIGS. 8A-8C). The bearing surface can be defined by cable latch edge 92 supported by a respective one of the cable latch arms 60. For instance, the cable latch 29 can include first and second cable latch edges 92 that are spaced from each other along the lateral direction A. In one example, the cable latch edges 92 can be defined by the cable latch arms 60. For instance, the cable latch edges 92 can be defined by the longitudinally forwardmost ends of the cable latch arms 60. The cable latch edges 92 can be inclined. For instance, the cable latch edges 92 can angle upward as they extend in the longitudinally forward direction. The cable latch edges 92 may be curved, straight, or alternatively shaped as desired. In some examples, the cable latch edges 92 can be oriented along the transverse direction T. As will be appreciated from the description below, the cable latch edges 92 are configured to ride along the inclined surfaces 90, respectively, of the module frame 52.

Operation of the cable latch 29 will now be described with additional reference to FIGS. 8A-8C. FIGS. 8A-8C show successive rotational orientations or positions of the cable latch 29 about the pivot axis defined by the pivot axle 31 in the first direction of rotation as the pivotable cable latch 29 moves from the open position to the closed position. The cable latch 29 is configured to move between the open position whereby the detachable cable assembly 15 (see FIG. 6A) can be attached to and detached from the interconnect module 10, and the closed position whereby the detachable cable assembly 15 is secured to the interconnect module 10 (see FIG. 8C).

In a first position shown in FIG. 8A, the cable latch 29 is spaced from the cable ferrule 23. Thus, when the cable latch 29 is in the first position, which can be referred to as an open position, the cable ferrule 23 to be inserted or removed from the interconnect module 10 without interference of the cable latch 29. The cable latch edges 92 can be aligned with respective ones of the inclined surfaces 90 of the module frame 52 along both the first direction of rotation, and a plane that is defined by the longitudinal direction L and the direction T. As the cable latch 29 rotates in the first direction of rotation from a first position shown in FIG. 8A to a second position shown in FIG. 8B, the abutment surfaces 86 of the cable latch 29 can contact the cable ferrule 23. The pivot axle 31 may be in any longitudinal position in the frame slot 56.

As the cable latch 29 is rotated further in the first direction of rotation to the locked position shown in FIG. 8C (see also FIGS. 6B-6C), the compression members 33 elastically deforms in the longitudinal direction L, which forces the cable ferrule against the optical block 78, as will now be described. In particular, the cable latch edges 92 can ride along the inclined surfaces 90 of the module frame 52, which drives the latch 29 in the insertion direction. In the closed position, the compression members 33 can be disposed between the camp surfaces 90 with respect to the lateral direction A.

The compression member 33 clears the cable ferrule 23 as the cable latch 29 is rotated to the closed position. When the cable ferrule 23 is disposed against the optical block 78 as the cable latch 29 is rotating toward the closed position, further rotation of the cable latch 29 toward the closed position causes the cable latch edges 92 to further ride downward along the inclined surfaces 90 of the module frame 52, which drives the pivot axle 31 to move in the insertion direction in the frame slot 56, for instance toward the rear end 53b of the module frame 52. The cable latch 29 can be translatably fixed to the pivot axle 31. When the pivot axle 31 has moved to the rearwardmost end of the frame slot 56, further movement of the latch 29 toward the closed position causes each compression member 33 to elastically compress along the longitudinal direction L with the abutment surface 86 in contact with the complementary face 89 of the ferrule 23. The elastic compression of the compression members 33 along the longitudinal direction increases the retention force that the abutment surfaces 86 apply to the face 89 of the ferrule 23, which thereby causes the ferrule 23 to similarly bear against the optical block 78 with the force applied to the ferrule 23 from the compression members 33. Otherwise stated, when the cable latch 29 is in its closed position (which can be referred to as a locked position), the cable latch 29, such as the compression member 33 and in particular the abutment surface 86, provides a force that is directed in the insertion direction of the ferrule 23, to a face 89 of the cable ferrule 23 forcing the ferrule 23 against the optical block 78. The cable latch edges 92 may be curved to provide a generally smooth pressure increase that forces the cable latch 29 to be driven in the insertion direction toward the rear end 53 of the module frame 52 as the cable latch 29 rotates downward into the interconnect module 10.

Advantageously, a location of the contact between the abutment surface 86 and the cable ferrule 23 does not shift, or shifts only minimally, while the compression member 33 is being deformed as the cable latch 29 rotates into its closed position. This eliminates or minimizes any rotational force that would otherwise be applied to the cable ferrule 23 as the cable ferrule 23 is forced against the optical block 78. When the cable latch 29 is in the closed position, the cable ferrule 23 is captured between the optical block 78 and the abutment surface 86. Thus, it may be said that the compression member 33 may be elastically deformed by the inclined surface 90 when the cable latch 29 is in the closed position and that the compression member 33 and inclined surface 90 secure the cable ferrule 23 in its mated position. The cable latch arms 60 do not transmit any of the compressive forces that secure the cable ferrule 23 to the optical block 78 when the cable latch 29 is in the closed position. When the cable latch 29 is in the its open position shown in FIG. 6A (which can be referred to as an unlocked position), the compression members 33 are removed from interference with the cable ferrule 23. Thus, the cable assembly 15 can be detached from the interconnect module 10.

A cable latch assembly can include the cable latch 29, the pivot member such as the pivot axle 31, and the structure of the frame 52 that engages the cable latch 29 and the pivot axle 31, such as the slot 56 and each inclined surface 90. In this regard, the cable latch assembly can further include the cable assembly 15. The cable latch assembly also provides sufficient pressure between the optical block 78 and the cable ferrule 23 over a sufficiently wide range of distances between the leading face 87 of the cable ferrule 23 and the opposed trailing face 89 (see FIG. 6A) of the cable ferrule 23 that it can accommodate variations in this distance that may naturally occur, for instance due to manufacturing during the manufacturing process. An advantage of the cable latch assembly is that the abutment surface 86 of each compression member 33 can pass over a top front edge 88 of the cable ferrule 23 with no or minimal interference when the cable latch 29 is moved from the open position to the closed position, and closed position to the open position, thereby preventing potential damage to the cable latch 29 and/or cable ferrule 23 that could otherwise occur if the cable latch 29 applied retention forces to the edge 88 of the cable ferrule 23.

The edge 88 can be defined by an intersection of the face 89 of the ferrule 23 and a top surface 123 of the ferrule 23. The top surface 123 can be substantially parallel to the major faces of the interconnect substrate 32. The cable ferrule 23 can extend down from the top surface 123 toward the interconnect module substrate 32. The top surface 123 can be the top-most surface of the ferrule 23, such that no other surfaces of the ferrule 23 are offset from the top surface 123 in the upward direction. The compression members 33 can be aligned with the edge 88 of the ferrule 23 along respective planes that are defined by the longitudinal direction L and the transverse direction T. As the cable latch 29 moves toward the closed position, a force, which can be a manual force, can cause the able latch 29, and thus the pivot axle 31, to travel in the forward or removal direction. The pivot axle 31 can move in the forward or removal direction in the slot 56 to a position whereby the compression members 33 moves over the ferrule 23 and past the ferrule 23, including the edge 88, in the rearward direction as the cable latch 29 moves to the closed position. While a surface of the compression member 33 may contact the edge 88 as the cable latch 29 moves to the closed position, the surface of the compression members 33 that contact the edge 88 is spaced in the upward direction from the abutment surface 86, and can be defined by the curved distal tip. The abutment members 86 are spaced from the edge 88 as the cable latch 29 travels to the closed position. Thus, the edge 88 is protected from the high retention forces delivered by the abutment members 86 when the compression members 33 elastically compress along the longitudinal direction.

As illustrated at FIG. 8B, the ramp surfaces 90 do not urge the latch edges 92, and thus the cable latch 29, in the rearward or insertion direction while the compression members 33, and in particular as the abutment surfaces 86, are moving past the edge 88 as the cable latch 29 moves in the first direction of rotation toward the closed position. For instance, the latch edges 92 can be spaced from the ramp surfaces while the compression members 33, and in particular as the abutment surfaces 86, are moving past the edge 88 as the cable latch 29 moves in the first direction of rotation toward the closed position. Thus, the compression members 33 do not generate the compression force until after the compression members 33 have passed over the cable ferrule 23, and in particular the edge 88. The latch edges 92 can begin riding along the ramp surfaces 90 once the compression members 33 have moved past the edge 88, such that the abutment surfaces 86 are aligned with the face 89 of the ferrule 23 along the longitudinal direction L. Thus, the compression members 33 do not begin elastically compressing until the abutment surfaces 86 have travelled past the edge 88 in the first direction of rotation. It is recognized that any inadvertent contact of the cable latch 29 with the edge 88 while the cable latch 29 is moving from the open position to the closed position can cause the pivot axle 31 to travel in the slot 56 in the rearward direction, which the causes the cable latch 29 to move in the rearward direction such that the cable latch 29 moves past the edge 88. Therefore, even if the cable latch 29 contacts the edge 88, the cable latch 29 does not apply the retention forces to the edge 88.

Similarly, when the cable latch 29 is moved from the closed position to the open position, the compression members 33 decompress to their respective natural states before the abutment surfaces 86 travel past the edge 88 of the ferrule in the second direction of rotation. In particular, as shown at FIGS. 8B and 8A, as the cable latch 29 is rotated in the second rotational direction, the latch edges 92 can be removed from the ramp surfaces 90 while the abutment surfaces 86 are aligned with the trailing face 89 of the ferrule 23. Thus, the cable latch 29 can be positioned such that the pivot axle 31 is disposed at a position in the slot 56 whereby the abutment members 86 remain spaced from the edge 88 in the removal direction as the cable latch 29 travels from the closed position to the open position. It is recognized that any inadvertent contact of the cable latch 29 with the edge 88 while the cable latch 29 is moving from the closed position to the open position can cause the pivot axle 31 to travel in the slot 56 in the rearward direction, which the causes the cable latch 29 to move in the rearward direction such that the cable latch 29 moves past the edge 88. Therefore, even if the cable latch 29 contacts the edge 88, the cable latch 29 does not apply the retention forces to the edge 88.

As the cable latch 29 moves toward the closed position, the lances 66 can ride along the module frame 52, which causes the lances to elastically deform, When the cable ferrule 23 is in its closed position, shown in FIG. 8C, the lances 66 may return to their original shape and releasably lock under ledges 94 of the module frame 52 frame as shown in FIG. 6C. This arrangement captures the cable latch 29 with respect to inadvertent rotation of the cable latch 29 in the second direction of rotation, and thus releasably locks the cable latch 29 in its closed position. In this regard, the lances 66 can be referred to as a lock engages with the module frame 52 so as to releasably lock the cable latch 29 in its closed position.

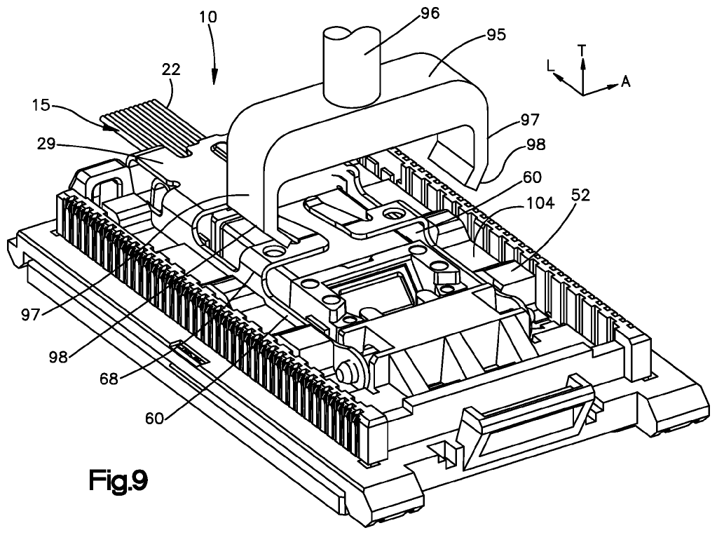

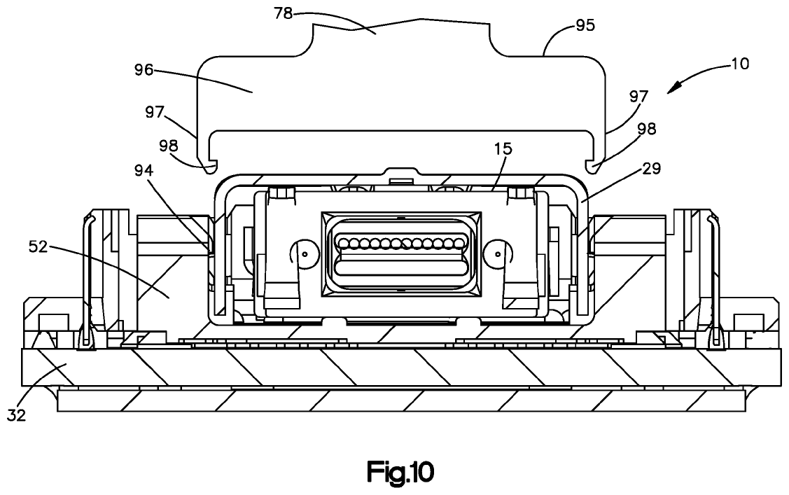

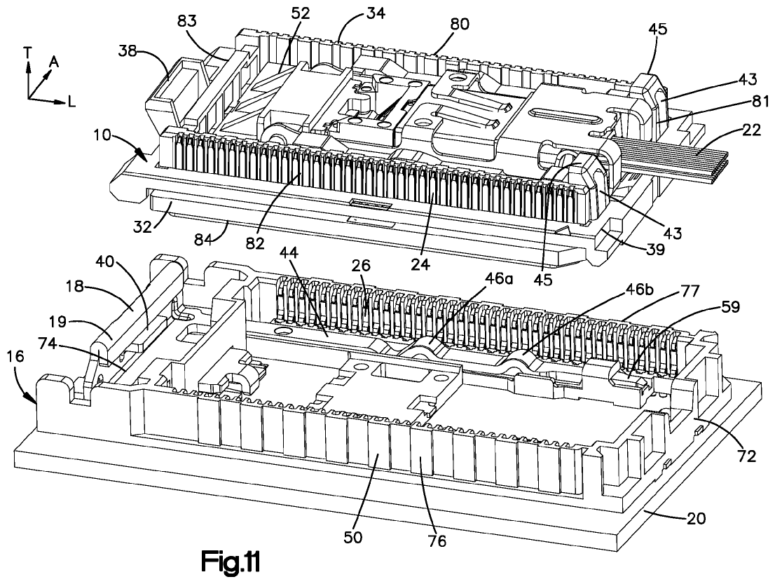

In one example, referring to FIGS. 9-10, the cable latch assembly can include a cable ejection tool 96 that is configured to disengage the lock, thereby unlocking the cable latch 29 from the module frame 52. When the lock is disengaged, the cable latch 29 is configured to rotate along the second direction of rotation toward the unlocked position. In one example, the cable ejection tool 96 is configured to apply an unlocking force to the cable latch that causes the lock of the cable latch 29 to disengage the module frame 52, thereby allowing the cable latch 29 to rotate in the second direction of rotation from the closed position to the open position. In one example, the cable ejection tool 96 can include a tool body 95 and a pair of support arms 97 that extend from the tool body 95. The support arms 97 are opposite each other along the lateral direction A, and terminate at unlatching hooks 98. The unlatching hooks 98 can face each other along the lateral direction A.

To unlatch the cable latch 29, the cable ejection tool 96 may be lowered over the engagement members of the cable latch 29, which as described above can be configured as dimples 68. Either or both of the support arms 97 and the unlatching hooks 98 can elastically deform or otherwise move away from each other as they pass over the engagement members of the cable latch 29 in the downward direction. The unlatching hooks 98 can engage undersides of the dimples 68 after the unlatching hooks 98 have cleared the dimples 68. In particular, the unlatching hooks 98 can be disposed between the dimples 68 and lances 66 of the cable latch 29. With the unlatching hooks 98 positioned past the dimples 68, the resilient natural biasing force of the cable ejection tool 96 or otherwise moving the unlatching hooks 98 toward each other forces the two cable latch arms 60 to elastically deflect toward each other a sufficient distance such that the lock of the cable latch 29 (which can be defined by the lances 66) is removed from interference with the ledges 94 of the module frame 52.

When the lock of the cable latch 29 is removed from interference with the module frame 52, the cable latch 29 can be rotated in the second direction of rotation until the cable latch 29 is in the open position shown in FIG. 6A. In particular, the elastic compression of the compression members 33 against the ferrule drives the latch 29 in the removal direction. Thus, each latch edge 92 is also driven to move in the removal direction. As the latch edges 92 move in the removal direction, the latch edges 92 ride along the ramp surface 90, which causes the latch edge 92 to move in the upward direction. Movement of the latch edge 92 causes the cable latch 92 to rotated in the second direction of rotation to the open position. Thus, disengaging the lock of the cable latch 29 from the module frame 52 can cause the cable latch 29 to automatically pivot from the closed position to the open position. As described above, the cable latch 29 can move in the removal direction as the pivot axle 31 rides in the slot 56, which causes the compression members 33 to be spaced from the edge 88 of the ferrule 23 a sufficient distance in the removal direction so as to allow the compression members 33 to move past the edge #with no or minimal interference with the edge 88 as the cable latch 29 rotates to the open position. With the cable latch 29 in the open position the cable assembly 15 can be readily removed from the interconnect module 10 in the removal direction by pulling the cable assembly 15 away from the optical block 78 in the forward direction and out the interconnect module 10.

In other examples, the cable ejection tool can include arms that extend into the holes 71 of the cable latch 29. The arms can be brought toward each other along the lateral direction A, which can cause force the two cable latch arms 60 to elastically deflect toward each other a sufficient distance such that the lock of the cable latch 29 (which can be defined by the lances 66) is removed from interference with the module frame 52 in the manner described above. In this regard, the cable ejection tool 96 can be configured as a c-ring pliers.

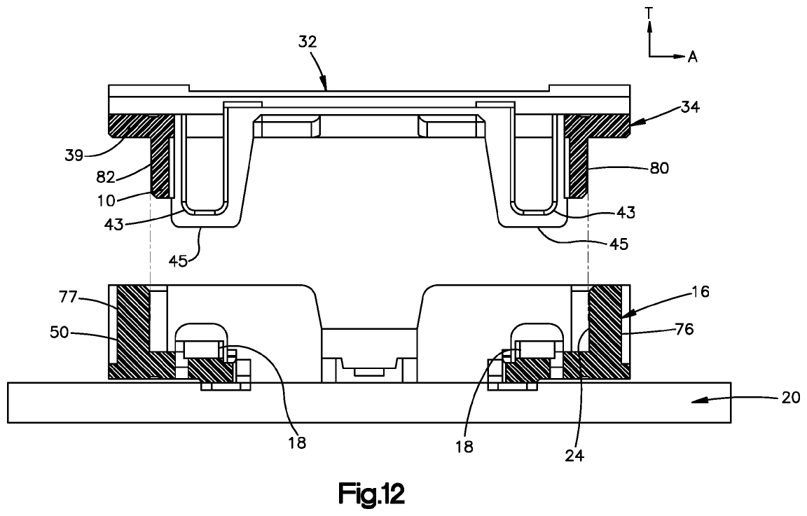

Referring now to FIG. 11, and as described above, the interconnect module 10 can be positioned adjacent the ring socket 16 with the ring socket latch 18 in an accept position according to one embodiment. FIG. 11 helps to illustrate the positioning of elements in the interconnect module 10 relative to the ring socket 16. To mate the interconnect module to the ring socket 16, the interconnect module would be flipped over along the transverse direction T so that the interconnect module 10 is aligned to be mated with the ring socket 16. The interconnect module 10 is then mated to the ring socket 16 by inserting the interconnect module 10 into the ring socket 16 in the mating direction that is defined by the transverse direction T as described above. The latch actuator 19 can be in the accept position while the interconnect module 10 is mated with the ring socket 16. One the interconnect module 10 has been inserted in the ring socket 16, the ring socket latch 18 can then be moved towards the ring socket housing 50 to the locked position so as to secure the interconnect module 10 to the ring socket 16. When the interconnect module 10 is mated to the ring socket, the first side 80 of the interconnect module 10 can ride along the first side 76 of the ring socket 16, and the second side 82 of the interconnect module 10 can ride along the second side 77 of the ring socket 16.

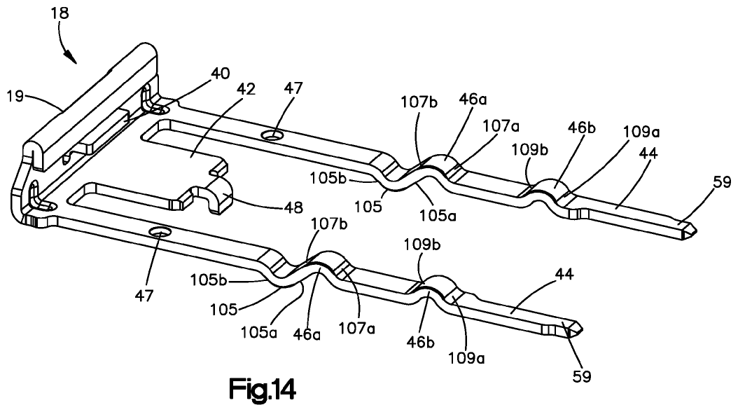

The ring socket latch 18 and the interconnect module 10 can define a plurality of interfaces that secure the interconnect module 10 with the ring socket 16 when the interconnect module 10 is mated with the ring socket 16, and the ring socket latch 18 is in the locked position. A first interface may between a first locking member, such as a locking bar 40, of the ring socket latch 18 and a complementary locking member, such as a body ledge 41 of a locking projection 38 (FIG. 13), of the module housing 34, and in particular of the module body 39. The locking bar 40 can extend in the first or forward direction from a body of the ring socket latch 18 that defines the latch actuator 19. The locking projection 38 can extend in the second or rearward direction and in the downward transverse (i.e., mate) direction from the first module end 81 of the module body 39. The locking projection 38 can define an opening therethrough so as to define the body ledge 41 that receives the locking bar 40 of the ring socket 16.

Second and third interfaces may be defined, respectively, between at least one latch arm 44 of the ring socket latch 18 and respective abutment members 45 of the interconnect module 10, and in particular the module housing 34. The at least one latch arm 44 can include first and second latch arms 44 that are opposite each other along the lateral direction A, and extend from the latch actuator 19 in the longitudinally forward direction. The abutment members 45 of the interconnect module 10 can be defined by a channel 43 that extends through the module housing 34 and is sized to receive the latch arms 44 and in particular respective distal free end portions 59 of the latch arms 44. The channel 43 can define the abutment members 45, though it should be appreciated that the abutment members 45 defined by any suitable alternative structure as desired. When the ring socket latch 18 is in the locked position, second locking members defined by the latch arms 44 can extend to a position aligned with the abutment members 45, respectively. The abutment members 45 can be adjacent the latch arms 44 in the mating direction. Thus, the abutment members 45 can be disposed between the latch arms 44 and the host substrate 20. Accordingly, a force applied to the interconnect module 10 with respect to the ring socket 16 in the unmate direction (away from the host substrate 20) causes the abutment members 45 to contact the latch arms 44. Thus, the latch arms 44 prevent the interconnect module 10 from separating from the ring socket 16 along the unmate direction.

Accordingly, the second and third interfaces can be defined when the latch 18 is in the locked position, and prevents the interconnect module 10 from being removed from the ring socket 16 along the unmate direction. As will be described in more detail below, when the latch 18 is moved to the accept and eject positions, the first, second, and third interfaces are removed.

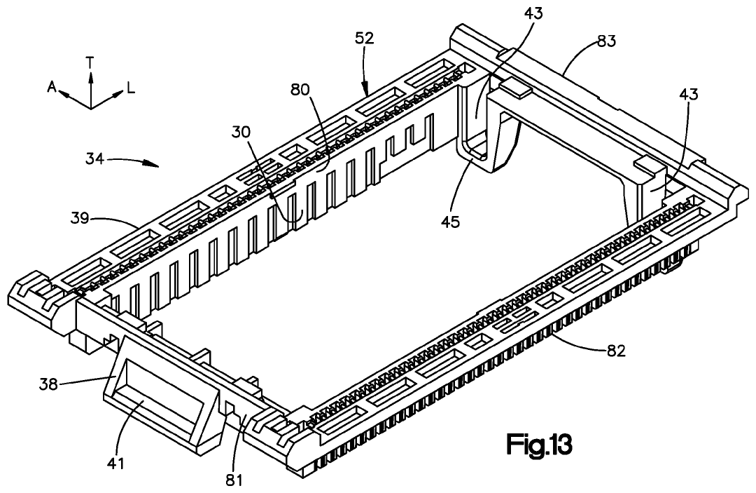

Referring now to FIG. 12, the interconnect module 10 is shown aligned to be mated to the ring socket 16 in the mating direction. The module housing 34 and the module substrate 32 can combined to define a cross-sectional T shape, while the ring socket 16 can form a cross-sectional U shape that can wrap around the vertical portion of the T-shape. When mated in the ring socket 16, the optical engine 28 (see FIGS. 3A-3B) and module housing 34 of the interconnect module 10 can be located between the module substrate 32 and the host substrate 20. Since at least a portion of one or more of the module substrate 32, the optical engine 28, and the module housing 34 can be located in between the rows of ring electrical contacts 26 of the ring socket 16, the total height of the mated interconnect module 10 and ring socket 16 above the host substrate 20 can be less than the sum of the total component heights. Similarly, since at least a portion of the module substrate 32 and the module housing 34 can be directly above the rows of module electrical contacts 24, a footprint of the ring socket 16 on the host substrate 20 can be as small or even smaller than the largest width of the interconnect module 10, as measured from the first module side 80 to the second module side 82.

The module housing 34 can be designed to have a portion that is narrower than the module substrate 32. This can allow the ring socket 16 that surrounds the module housing 34 on two or more sides to be as small as possible (up to not being wider/larger that the module substrate 32). In other words, it allows maximization of the size of the module substrate 32 for a given ring socket 16 footprint. This ensures a maximum width and/or length available for the optical engine 28. Maximizing the available module substrate 32 space helps accommodate larger transimpedance amplifier and laser driver dies, while minimizing the overall footprint on the host substrate 20. The module housing 34, and in particular the module frame 52, can function to protect the optical engine 28 from environmental factors and seal it from the external influences. The seal can be hermetic or non-hermetic.

The module housing 34 can formed from a polymer and be attached to the module substrate 32 by any known means. For example, the module housing 34 can be injection molded and epoxied to the module substrate 32. If the module housing 34, and in particular the module body 39, supports the module electrical contacts 24, it can be reflowed to solder the module electrical contacts 24 to the module substrate 32. Epoxy can then be applied to form a seal between the module housing 34 and the module substrate 32. The module housing 34 may be made of a single component or a plurality of components. In this embodiment the module housing 34 can be thick and have or define a cavity for the optical engine 28 to fit in. This enables the module substrate 32 to be relatively thin, since it does not need a deep cavity in which to situate the optical engine 28.

The module housing 34, the module substrate 32, can form part of a protective enclosure around the optical engine 28. Forming a protective enclosure around the optical engine 28 can increase environmental resilience of the interconnect module 10. Separating the optical coupling function and the sealing function allows simplifying the optical block 78 design and provides more design freedom to optimize optical coupling. It can also improve manufacturability.

FIG. 13 shows a perspective view of the module housing 34 and FIG. 14 shows a perspective view of the ring socket latch 18 according to one example. Both the module housing 34 and the ring socket latch 18 may be symmetric about the same bisecting plane defined by the longitudinal direction L and the transverse direction T. The module housing 34 includes the locking projection 38 and the body ledge 41. As described above, the body ledge 41 may engage with the locking bar 40 of the ring socket latch 18 when the ring socket latch 18 is in its locked position. Similarly, end portions 59 of the latch arms 44 of the ring socket latch 18 may extend into the locking channels 43 of the module housing 34 when the ring socket latch 18 is in its locked position. The interconnect module 10 may thus be secured into the ring socket 16 by the first interface between the body ledge 41 and locking bar 40 and the second and third interfaces between the end portions 59 (see FIG. 14) of the module latch arms 44 and the abutment members 45 that form an edge of the two locking channels 43 in the interconnect module housing 34.

FIG. 14 shows additional features of the ring socket latch 18. Each of the latch arms 44 may have a least one lifter such as a plurality of lifters. For instance, each of the latch arms 44 may include a first upward lifter 46a and second upward lifter 46b spaced from the first lifter 46a in the longitudinally forward direction. The first and second upward lifters 46a and 46b can be aligned with each other along the longitudinal direction, and can be differently shaped from each other. The first and second upward lifters 46a and 46b protrude in the upward direction. The upward lifters 46a and 46b can be defined by raised portions or ramps of the latch arms 44 that are raised in the upward direction. Each of the upward lifters 46a and 46b can define a leading ramped latch surface and a trailing ramped latch surface. The leading ramped latch surface is spaced from the trailing ramped latch surface along the forward direction. For instance, the first upward lifter 46a can define a first leading ramped latch surface 107a and a first trailing ramped latch surface 107b. The first leading latch ramped surface 107a can extend downward as it extends in the forward direction. The first trailing latch ramped surface 107b can extend upward as it extends in the forward direction. The second upward lifter 46b can define a second leading ramped latch surface 109a and a second trailing ramped latch surface 109b. The second leading latch ramped surface 109a can extend downward as it extends in the forward direction. The second trailing latch ramped surface 109b can extend upward as it extends in the forward direction.

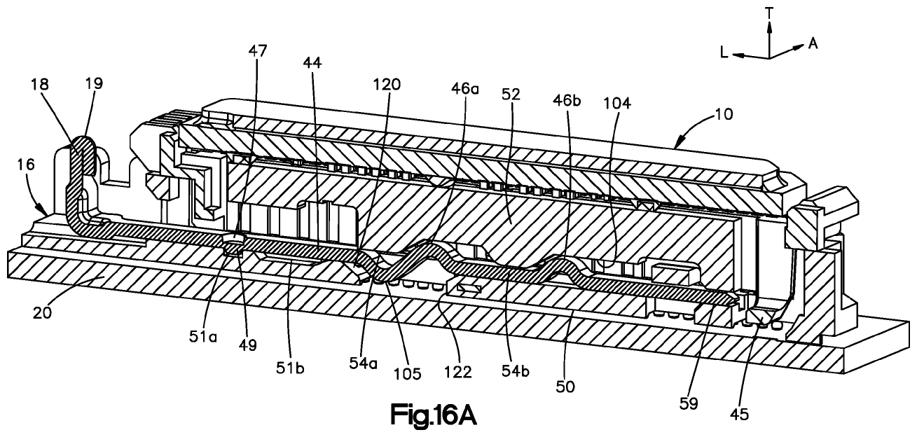

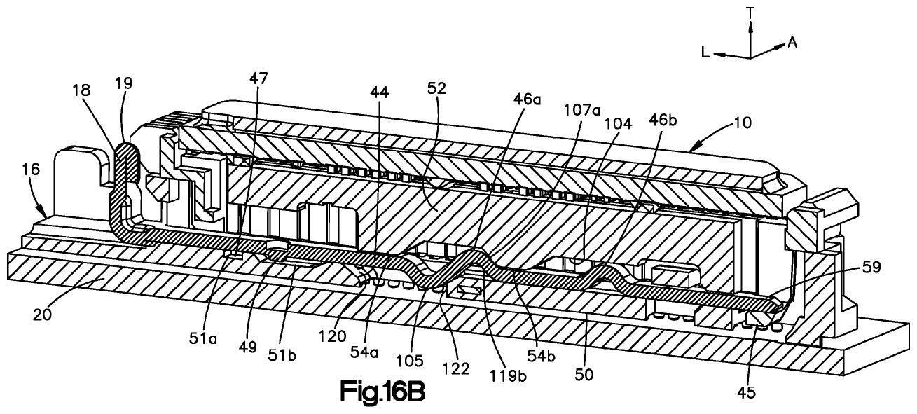

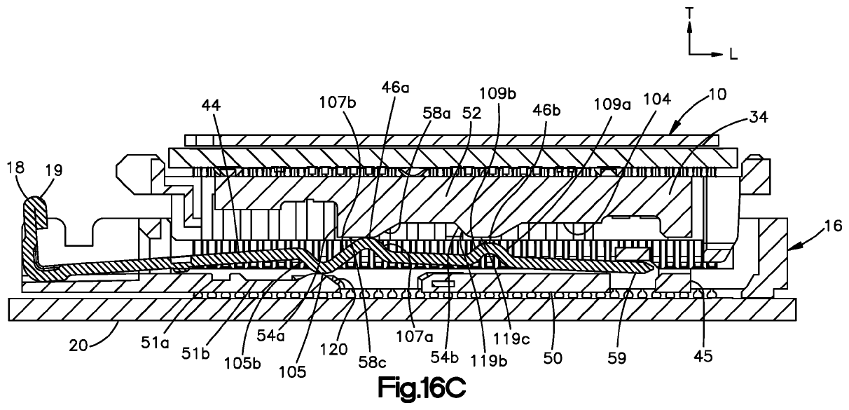

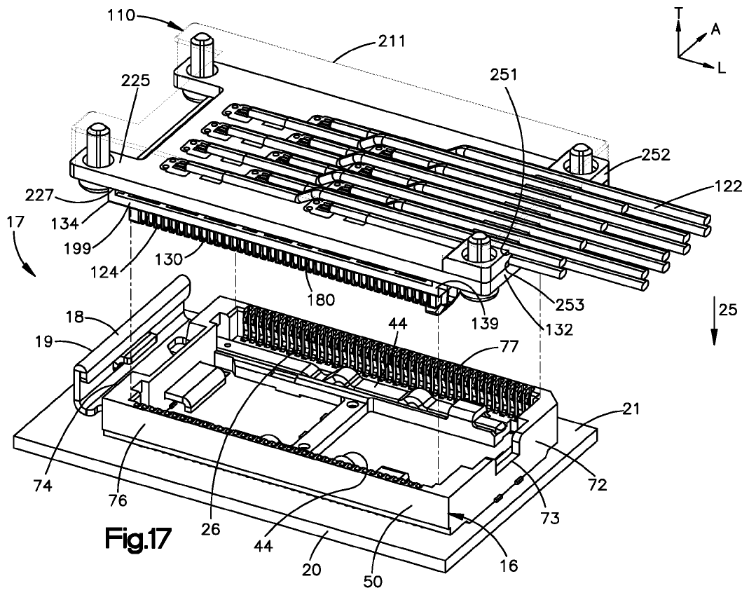

Each latch arm 44 can further include a second or downward lifter 105 positioned such that the first upward lifter 46a is disposed between the downward lifter 105 and the second upward lifter 46b along the longitudinal direction. The downward lifter 105 can project in the downward direction. The downward lifter 105 can similarly define a leading ramped downward lifter surface 105a and a trailing ramped downward lifter surface 105b. The leading ramped downward lifter surface 105a can extend in the upward direction as it extends in the forward direction. The trailing ramped downward lifter surface 105b can extend in the downward direction as it extends in the forward direction. The ring socket latch 18 may also have an embossment 47 on each arm 44. The embossments 47 form dimples 49 that project in the downward direction (see FIG. 16A), and can register the ring socket latch 18 with respect to the interconnect module housing 34 at least at some of its positions as described in more below. It should be appreciated that the dimples 49 can be defined by embossments in one example, the dimples 49 can be formed in any suitable alternative manner as desired.

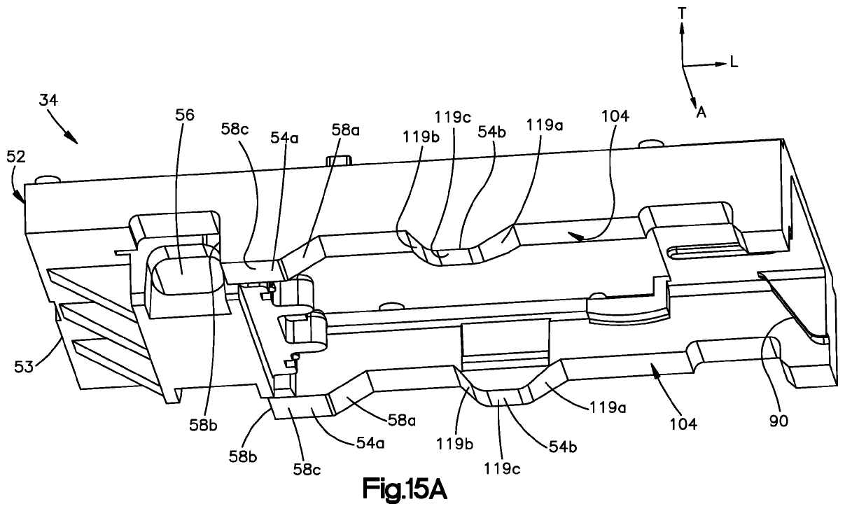

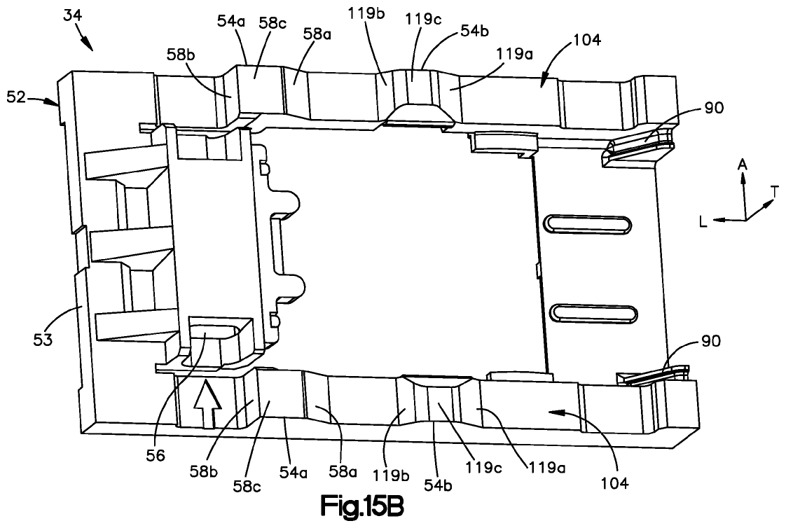

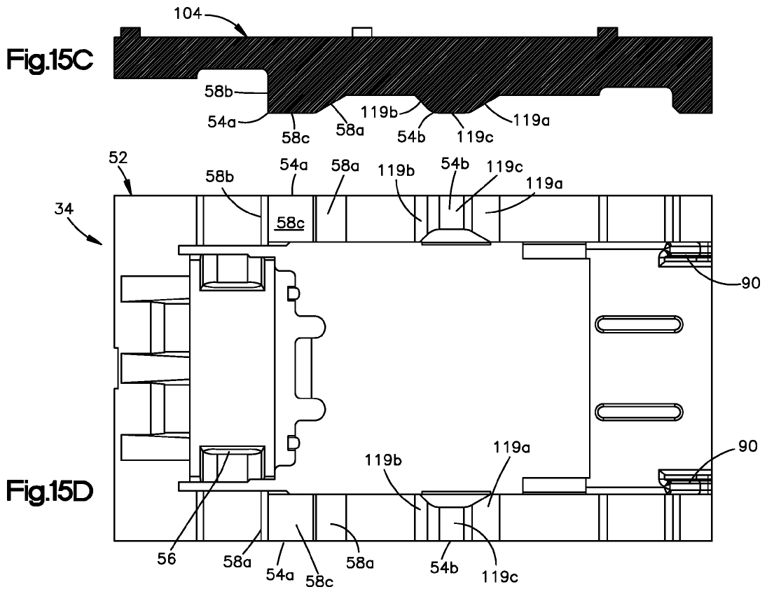

Referring now to FIGS. 15A-15D, the module frame 52 and thus the module housing 34 can include at least one rail 104, such as first and second rails 104, that are configured to engage respective arms 44 of the latch 18 described above with respect to FIG. 14. In particular, each rail 104 can include a plurality of protrusions configured to interface with the latch of the mated ring socket 16 so as to selectively secure the interconnect module 10 to the ring socket 16. The rails 104 can be opposite each other along the lateral direction A. The rails 104 can be disposed laterally inward with respect to the module sides 80 and 82, respectively (see FIG. 3A). Thus, the rails 104 can be disposed between the module sides 80 and 82 with respect to the lateral direction A (see FIG. 3A). The rails 104 can be monolithic with the module sides 80 and 82, or can alternatively be a separate structure from either or both of the module sides 80 and 82. In this regard, the rails 104 can be independently mounted to the module substrate 32 as desired.

Each of the rails 104 can define at least one protrusion such as a first protrusion 54a and a second protrusion 54b spaced from the first protrusion 54a in the longitudinal forward direction. The first and second protrusions 54a and 54b can extend in the downward direction. The first protrusion 54a can define a first leading ramped rail surface 58a that extends upward as it extends in the forward direction, and a first trailing rail surface 58b that can be oriented substantially along the transverse direction T or can be ramped. The first protrusion 54a can define a first rail flat 58c that extends between the first leading ramped rail surface 58a and the first trailing rail surface 58b. The second ramp protrusion 54b can define a second leading ramped rail surface 119a that extends upward as it extends in the forward direction, and a second trailing ramped rail surface 119b that extends downward as it extends in the forward direction. The second protrusion can define a second rail flat 119c that extends between the second leading ramped rail surface 119a and the second trailing ramped rail surface 119b.

Referring now to FIG. 16A, the ring socket housing 50 can define at least one ramped housing surface 120 and at least one housing stop surface 122. The at least one housing stop surface 122 can be spaced from the at least one ramped housing surface 120 in the forward direction. The at least one ramped housing surface 120 can extend in the downward direction as it extends in the forward direction. Each of the at least one ramped housing surface 120 and the at least one housing stop surface 122 can be aligned with the latch arms 44. For instance, a single continuous ramped housing surface 120 and a single continuous housing stop surface 122 can be aligned with each of the latch arms 144. Alternatively, first and second ramped housing surfaces 120 and first and second housing stop surfaces 122 can be aligned with respective ones of the latch arms 144.

The ring socket housing 50 can further define one or more pockets, such as a first pockets 51a and a second pockets 51b. The second pocket 51b can be spaced from the first pocket 51a in the forward direction. As will be described, the dimple 49 can define a beveled or ramped leading dimple surface with respect to the forward direction that allows the dimple to travel from the first pocket 51a to the second pocket 51b. Alternatively or additionally, the first pocket 51a can be partially defined by a leading ramped surface that allows the dimple 49 to travel out of the first pocket 51a and into the second pocket 51b. The second pocket 51b can be partially defined by a trailing ramped surface that allows the dimple 49 to travel from the second pocket 51b to the first pocket 51a. Alternatively or additionally, the trailing end of the dimple 49 can be ramped that allows the dimple 49 to travel in the rearward direction from the second pocket 51b to the first pocket 51a.

Operation of the latch 18 of the ring socket 16 and the rails 104 of the interconnect module 10 will now be described in detail with respect to FIGS. 16A-16C. In particular, the ring socket latch 18 is movable with respect to the rails 104 between the accept position, the locked position, and the eject position. The rails 204 can remain stationary as the latch 18 moves between its various positions. As shown in FIG. 16A the interconnect module 10 is mated with the ring socket 16 with the ring socket latch 18 in the accept position. When the ring socket latch 18 is in the accept position, the dimples 49 of the module latch arms 44 can be disposed in the first pockets 51a, respectively. Alignment of the dimple 49 with the first pocket 51a helps to register the ring socket latch 18 in the accept position. The accept position may be an intermediate position between the minimal spacing and the maximum spacing of the latch actuator 19 from the ring socket housing 50. The first pocket 51a can be sized and positioned such that the dimples 49 abut the ring socket housing 50 at a forward end of the first pocket 51a when the dimples 49 attempt to travel in the forward direction a sufficient distance to move the ring socket latch 18 to the locked position. The abutment between the ring socket housing 50 at the first end of the first pockets 51a and the dimples 49 prevent the ring socket latch 18 from inadvertently moving to the locked position. Further, when the ring socket latch 18 is disposed in the accept position, each of the first upward lifters 46a of the latch 18 is disposed between the first and second protrusions 54a and 54b of the rails 104, respectively, with respect to the longitudinal direction. Further, each of the second upward lifters 46b of the latch 18 can be spaced from the second protrusion 54b in the forward direction.

When the latch 18 is in the accept position shown in FIG. 16A, the locking bar 40 (see FIG. 14) of the ring socket latch 18 is spaced from the body ledge 41 of a locking projection 38 (see FIG. 13) of the module housing 34. Thus, the first interference is removed. Additionally, when the latch 18 is in the accept position, the end portions 59 of the latch arms 44 can be spaced in the rearward direction from the abutment members 45 of the interconnect module housing 34, and thus out of alignment with the abutment members 45. Thus, the second and third interferences are removed. Accordingly, the latch 18 does not prevent the interconnect module 10 from being mated to the ring socket 16 in the manner described above. It is recognized that the mated interconnect module 10 can be removed from the ring socket 16 when the latch 18 is in the accept position. However, the latch 18 does not urge the interconnect module 10 to unmate from the ring socket 16 when the latch 18 is in the accept position. Rather, as described below, the latch 18 can urge the mated interconnect member 10 out of the ring socket 16 when the latch is in the eject position.

Referring now to FIG. 16B, when an actuation force is applied to the latch 18, and for instance to the latch actuator 19, in the first direction toward the interconnect module housing 34, the latch 18 can move from the accept position shown in FIG. 16A to the locked position shown in FIG. 16B. The latch actuator 19 is disposed closer to the ring socket housing 50 in the locked position compared to when the latch actuator 19 is in the accept position. As described above, when the latch 18 is in the locked position, the interferences can be engaged. In particular, the locking bar 40 (see FIG. 14) of the ring socket latch 18 is inserted into the opening of the locking projection 38. Thus, the locking bar 40 is aligned with the body ledge 41 of a locking projection 38 (see FIG. 13) in the upward direction, which is directed away from the host substrate 20. Because the body ledge 41 is located at a rear end of the interconnect module 10, interference between the locking bar 40 and the body ledge 41 prevents the rear end of the interconnect module 10 from being removed from the ring socket 16. Further, the end portions 59 of the latch arms 44 are driven to a position in alignment with the respective abutment members 45 of the interconnect module housing 34. In particular, the end portions 59 are adjacent the abutment members 45 in the upward direction. Because the abutment members 45 of the interconnect module housing 34 can be located at a front end of the interconnect module housing 34, interference between the locking bar end portions 59 of the larch arms 44 and the abutment members 45 prevent the front end of the interconnect module 10 from being removed from the ring socket 16.

When the latch 18 moves from the accept position to the locked position, the dimple 49 translates out of the first pocket 51a, and into the second pocket 51b. Abutment between the latch arms 44 and either or both of the interconnect module housing 34 and the ring socket housing 50 can limit movement of the latch 18 in the forward direction as it moves from the accept position to the locked position. For instance, the leading first upward lifters 46a of the latch arms 44 can abut the second protrusions 54b, respectively, of the rails 104. In particular, the first leading ramped latch surfaces 107a of the first upward lifters 46a can abut the second trailing ramped rail surfaces 119b of the second protrusions 54b. Further, the second downward lifter 105 of each latch arm 44 can abut the at least one housing stop surface 122. In particular, the leading ramped downward lifter surface leading 105a of the downward lifter 105 can abut the at least one housing stop surface 122. Interference between the dimple 49 and the rear end of the second pocket 51b can prevent the inadvertent movement of the latch 18 from the locked position shown in FIG. 16B to the accept position shown in FIG. 16A.

Referring now to FIGS. 16B-16C, the latch 18 can move from the locked position to the accept position and then to the eject position. In particular, a force is applied to the latch 18 in the rearward direction sufficient to cause the latch 18 to move in the rearward direction from the locked position to the accept position, and from the accept position to the eject position. In particular, the force is sufficient to cause the dimple 49 to move from the second pocket 51b to the first pocket 51a. The force is further sufficient to cause the dimple 49 to move from the first pocket 51a to a position spaced from the first pocket 51a in the rearward direction when the latch is in the eject position shown in FIG. 16C.

Referring now to FIG. 16C in particular, when the latch 18 is moved to the eject position, the interferences are removed in the manner described above with respect to the accept position. Further, the first upward lifters 46a of the latch arms 44 ride in the rearward direction along the first protrusions 54a of the interconnect module housing 34. In particular, the first trailing ramped latch surface 107b of the first upward lifter 46a rides along the first leading ramped rail surface 58a of the first protrusion 54a. This causes the latch arm 44 to urge a rear portion of the interconnect housing 34, and thus the interconnect module 10 to move away from the ring socket 16 in the upward unmate direction until the first upward lifter 46a rests against the flat 58c of the first protrusion 54a.

Further, with continuing reference to FIG. 16C, the trailing ramped downward lifter surface 105b of the downward lifter 105 of each latch arm 44 rides in the rearward direction from the accept position along the respective at least one ramped housing surface 120. The downward lifters 105 can rest on the ramped housing surfaces 120, respectively, which further causes the rear portion of the interconnect module 10 to move away from the ring socket 16 in the upward unmate direction.

Additionally, the first upward lifters 46a and the downward lifter 105 ride along the first protrusions 54a and the ramped housing surfaces 120, respectively, which cause the second upward lifters 46b of the latch arms 44 to ride in the rearward direction along the second protrusions 54b of the interconnect module housing 34. In particular, the second trailing ramped latch surface 109b of the second upward lifters 46b ride along the second leading ramped rail surface 119a of the second protrusion 54b. This causes the latch arm 44 to begin urging a front portion of the interconnect housing 34, and thus the interconnect module 10 to move away from the ring socket 16 in the unmate direction. However, as the first upward lifter 46a and the downward lifter 105 of the latch arms 44 continue to ride along the first protrusion 54a and the ramped housing surface 120, respectively, the front portion of the interconnect module can move out of the ring socket 16, which causes the second protrusion 54b to become spaced from the second lifter 46b in the upward unmate direction. In one example, this can cause the latch arms 44 to elastically flex, and return to its initial shape after the interconnect module 10 is removed from the ring socket 16. Once the interconnect module 10 has been ejected from the ring socket 16 by the latch arms 44, the interconnect module 10 can be easily removed from the ring socket 16. It is appreciated that the latch arms 44 may not fully eject the interconnect module 10 completely out of the ring socket 16, but ejects the interconnect module 10 a sufficient distance in the unmate direction so that the interconnect module 10 can be easily removed from the ring socket 16.

Referring again to FIGS. 16A-16C, the longitudinally forward direction can be referred to as a locking direction whereby the latch 18 moves from the accept position to the locked position, and the longitudinally rearward direction can be referred to as an ejecting direction whereby the latch 18 moves from the locked position to the eject position. It should be readily appreciated in other examples that the latch arms 44, the rails 104, and the ring socket housing 50 can be configured such that the forward direction defines the ejecting direction, and the rearward direction defines the locking direction. It can be advantageous, however, in some examples for the rearward direction to define the ejection direction. In particular, the latch 18 can experiences the highest forces when moving the latch 18 to the ejection direction. Rearward motion of the latch 18 is effected by a pulling force in the rearward direction, which can better maintain the structural integrity of the latch with respect to a forward motion of the latch 18 effected by a pushing force that would move the latch 18 in the ejection direction.

As described above, the interconnect assembly 17 can include the ring socket 16 and the interconnect module 10 that can be configured as an optical interconnect module that is an optical transmitter, receiver, or transceiver.

Alternatively, referring to FIG. 17, the interconnect module can be configured as an electrical interconnect module 110. Thus, the interconnect assembly 17 can include the ring socket 16 and the electrical interconnect module 110 that is configured as an electrical transmitter, receiver, or transceiver. The transceiver can provide the functions of both an electrical transmitter and an electrical receiver. The ring socket 16 configured to mate with the electrical interconnect module 110 can be identical to the ring socket 16 described above that is configured to mate with the optical interconnect module 10. Thus, the ring socket 16 includes the ring socket housing 50, the ring socket latch 18, and all other structure of the ring socket described above.

The electrical interconnect module 110 will be described with reference numerals corresponding to like elements of the optical interconnect module 10 incremented by 100 for the purposes of clarity and convenience. As will be described from the description below, the electrical interconnect module 110 can be devoid of the optical block, the engine substrate, the frame, and the cable latch assembly of the optical interconnect module 10. FIG. 17 shows the electrical interconnect module 110 positioned above the ring socket 16 along the transverse direction T, and aligned to be mated with the ring socket 16 in the mating direction 25. The electrical interconnect module 110 may be a low-profile, electrical connector that can selectively mate with and unmate from the ring socket in the respective mating and unmate directions that can be substantially normal to the major upper surface 21 of the host substrate 20 to which the ring socket 16 is mounted. Thus, the interconnect module assembly can have the low profile described above.

The ring socket 16, and in particular the ring socket housing 50 and the rows of ring electrical contacts 26, can be configured to fully constrain the electrical interconnect module 110 along all directions substantially parallel to the major surface 21 of the host substrate 20 when the electrical interconnect module 110 is mated with the ring socket 16. That is, the ring socket 16 can be configured to constrain the electrical interconnect module 110 along each of the longitudinal direction L and the lateral direction A. Further, the ring socket latch 18 of the ring socket 16 can prevent the electrical interconnect module 110 from unmating from the ring socket 16 along the transverse direction T as described above with respect to the optical interconnect module 10.

The interconnect module 110 can include a module housing 134 and a plurality of module electrical contacts 124 supported by the module housing 134. The module housing 134 can be defined by the module body 139, which can define the base 199 and the outer frame 130 in the manner described above with respect to the interconnect module 10. The module electrical contacts 124 can be arranged in first and second rows that are can be spaced apart along the lateral direction A. Adjacent ones of the module electrical contacts 124 of each row may be separated from each other by a constant pitch along the longitudinal direction L. The pitch of the module electrical contacts 124 of the electrical interconnect module 110 can be the same as the pitch of the module electrical contacts 24 of the interconnect module 10 described above. The module electrical contacts 124 are configured to physically contact the ring electrical contacts 126 and provide an electrical connection between them when electrical interconnect module 110 is mated with the ring socket 16. Thus, the optical interconnect module 10 and the electrical interconnect module 110 can be interchangeably mated with the ring socket 16.

The electrical interconnect module 110 may include a module substrate 132, which can be configured as a printed circuit board, such that cables 122 are configured to be permanently mounted to a first major surface 225 (see FIG. 18B) of the module substrate 132. An interconnect module cable assembly can be defined when the cables 122 are mounted to the module substrate 132. Permanently mounted indicates that the cables 122 are not removable from the module substrate 132 without damaging the cables 122, the module substrate 132, or both. In one example, the cables 122 are soldered to the module substrate 132. The cables 122 can extend out from the module housing 134, for instance along the longitudinal direction L. The cables 122 can be electrical cables that are permanently mounted to the module substrate 132. The module substrate 132 can include electrical traces that route the electrical signals from the cables 122 to respective ones of the module electrical contacts 124. Thus the cables 122 are in electrical communication with the module electrical contacts 124. In other examples, the cables 122 can be detachable and re-attachable to the electrical interconnect module 110 as desired. The electrical cables 122 can be coaxial cables, twinaxial cables, or any alternatively configured electrical cables. It should be appreciated that the cables 122 can be in data communication with the module electrical contacts 124, such that electrical signals from the contacts 24 can routed along the cables 22. Conversely electrical signals received from the cables 22 can be routed to the module electrical contacts 24.

When the electrical interconnect module 110 is configured as an electrical transmitter, the interconnect module 110 is configured receive electrical signals from the host substrate 20 through the ring electrical contacts 26 to the module electrical contacts 124 when the electrical interconnect module 110 is mated with the ring socket 16, and transmit the electrical signals from the module electrical contacts 124 to the module substrate 132, and along the electrical cables 122 to an external device. As a receiver, the electrical interconnect module 110 is configured to receive the signals from the cables 122 and direct the signal to the interconnect module substrate 132, which routes the electrical signals to the module electrical contacts 124. The electrical signals then get routed from the module electrical contacts to the ring contacts 26, and ultimately to the host substrate 20 when the interconnect module 110 is mated with the ring socket 16.

Thus, the electrical interconnect module 110 is configured to mate with the ring socket 16 to form the interconnect assembly 17 for high-speed data transmission. When the ring socket 16 is mounted to the host substrate 20 and the electrical interconnect module 110 is mated to the ring socket 16, the electrical interconnect module 110 is placed in data communication, such as electrical communication, with the host substrate 20. The electrical interconnect module 110 can be arranged to vertically mate with the ring socket 16, in the illustrated mating direction 25 that is oriented along the transverse direction T. A signal connection between the electrical interconnect module 110 and a corresponding receptacle connector, such as ring socket 16, can be electrical in nature and can be established by mating at least one electrically conductive contact, such as a ring electrical contact 26, in the ring socket 16 with at least one corresponding electrically conductive module contact 124 in the electrical interconnect module 110. The electrical connection can be established by inserting the electrical interconnect module 110 in a substantially downward or transverse mating direction 25 into the ring socket 16, the host substrate 20, or both. Contact forces between one or more of the electrically conductive module contacts 124 of the electrical interconnect module 110 and respective, corresponding one or more of the ring electrical contacts 26 of the ring socket 16 may be substantially normal to the mating direction 25 between the electrical interconnect module 110 and ring socket 16, such as in the illustrated lateral direction A. The downward mating direction 25 is defined in FIG. 17 as a direction perpendicular to and towards host substrate 20 at the major surface 21 without first travelling through an opposed major surface that is opposite the major surface 21.

Referring now to FIGS. 17-18B, the electrical interconnect module 110 can include the module body 139 and the plurality of module electrical contacts 124 supported by the module body 139. For instance, the module electrical contacts 124 can be supported by the frame 130. Thus, it can be said that the module electrical contacts 124 are supported by the module housing 134. The module housing 134 can include the module body 139, which includes the module base 199 and the outer frame 130. In this regard, components of the module body 139 can also be considered as components of the module housing 134.

The outer frame 130 can extend out with respect to the module base 199 along the transverse direction T, and in particular in the unmate direction. The module base 199 can surround the outer 130 with respect to each of the longitudinal direction L and the lateral direction A. The module housing 134, including the module body 139, can be mounted to a second major surface 227 of the module substrate 132 that is opposite the first major surface 225. The module base 199 and the outer frame 130 can define a unitary monolithic structure in one example. In this regard, module the base 199 can be mounted to the module substrate 132, which thereby causes the outer frame 130 to also be mounted to the module substrate 132. Alternatively, the outer frame 130 can be mounted to the module substrate 132, which thereby causes the module base 199 to also be mounted to the module substrate 132. In still other examples, each of the module base 199 and the outer frame 130 can be mounted to the module substrate 134. For instance, the module base 199 and the outer frame 130 can define separate structures as desired.

With continuing reference to FIGS. 17-18B, the outer frame 130, and thus the module housing 134, can include sides and ends that extend out with respect to the base 99 along the transverse direction T. The sides can include a first module side 180 and a second opposed module side 182 that is opposite the first module side 180 along the lateral direction A. The ends can include a first module end 181 and a second module end 183 that are opposite each other along the longitudinal direction L. The sides 180 and 182 and the ends 181 and 183 can extend from the base 199 in the transverse direction T, and in particular in the unmate direction. The module sides 180 and 182 can extend between the first and second module ends 181 and 183, respectively. For instance, the module sides 180 and 182 can extend from the first module end 181 to the second module end 183. Thus, the module sides 180 and 182 and the module ends 181 and 183 can at least partially define the outer frame 130. The base 199 can surround the outer frame 130, including each of the module sides 180 and 182 and the module ends 181 and 183.

The module sides 180 and 182 can each extend a first distance along the longitudinal direction L, and the module ends 181 and 183 can each extend a second distance along the lateral direction A. The second distance can be less than the first distance. The module sides 180 and 182 and module ends 181 and 183 can cooperate to define an internal module void 185. The first direction or forward direction can extend in the longitudinal direction L from the second module end 183 toward the second module end 181. The second direction or rearward direction can extend in the longitudinal direction L from the second module end 183 toward the first module end 181. Thus, a front end of the module housing 134 can be defined by the second module end 183, and a rear end of the module housing 134 can be defined by the first module end 181. It should be appreciated that the terms “front” and derivatives thereof used with respect to any component, such as the interconnect module 110, refer to a location in the forward direction, and the term “rear” and derivatives thereof refer to a location in the rearward direction. Thus, a front portion can be spaced from a rear portion in the forward direction. Conversely, a rear portion can be spaced from the front portion in the rearward direction.

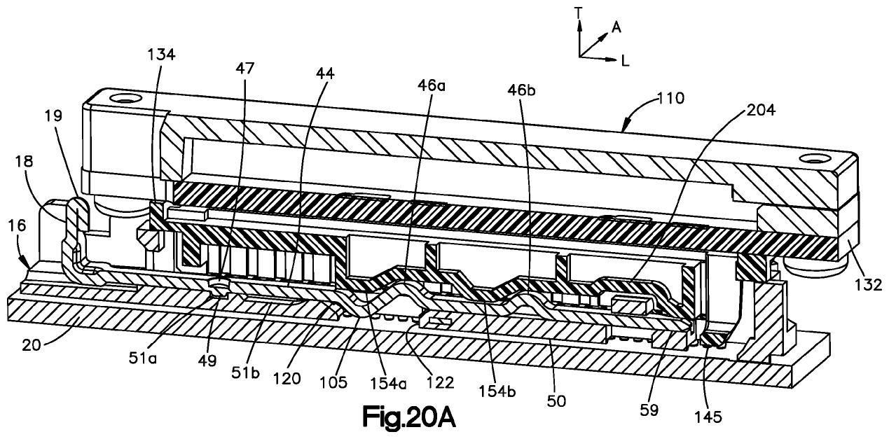

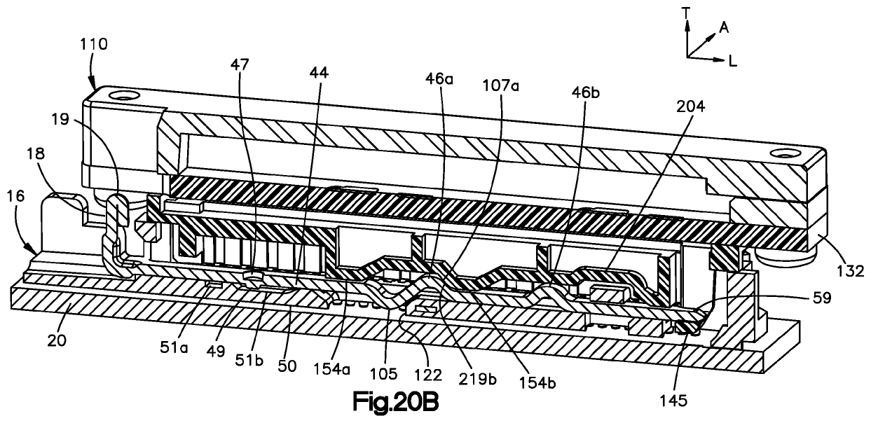

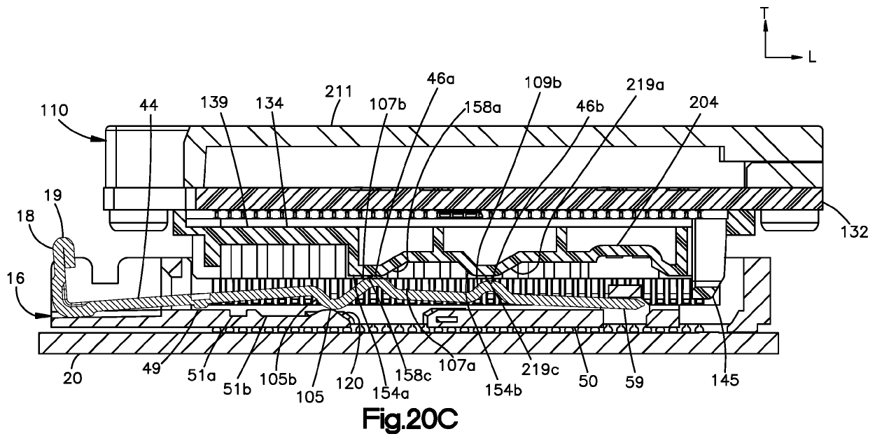

The module electrical contacts 124 can be supported by the module housing 134, and in particular can be supported by the outer frame 130. The module electrical contacts 124 can be arranged in respective rows. For instance, the first and second module sides 180 and 182 can each carry respective rows of the module electrical contacts 124. The module electrical contacts 124 can be constructed substantially identical (i.e., within manufacturing tolerance) to each other. Each of the respective rows of module electrical contacts 124 can be oriented parallel to each other. For instance, the rows can be arranged along respective linear arrays that extend along the longitudinal direction L. The module electrical contacts 124 can define mating ends that face away from the internal void 185, and thus face toward the mating ends of the ring electrical contacts 126 when the electrical interconnect module 110 is mated to the ring socket 16 (see FIG. 17 and FIGS. 20A-20B).

The module electrical contacts 124 can be supported by each of the first and second module sides 180 and 182. The electrical interconnect module 110 can be devoid of module electrical contacts 124 along the first and second module ends 181 and 183. Thus, it can be said that the module electrical contacts 124 can be arranged along the two long sides of the electrical interconnect module 110. Accordingly, first and second rows of the module electrical contacts 124 can be supported by the first and second module sides 80 and 82, respectively. The module electrical contacts 124 can be arranged to have a uniform pitch between adjacent contacts. It should be appreciated that, in one example, all rows of module electrical contacts 124 can be retained by a single body module housing 134. Alternatively, the electrical interconnect module 110 can include at least first and second bodies that support respectively the first and second rows of module electrical contacts 124. Each of the first and second bodies can be linked together by at least one interconnect module mechanical link member, which can be disposed at one or both of the respective longitudinal ends of the module housing 134. When the interconnect module 10 is mated with the ring socket 16, the module electrical contacts 24 at the first side 80 of the interconnect module 10 mate with ring electrical contacts 26 at the first side 76 of the ring socket 16, and the module electrical contacts 24 at the second side of the interconnect module 10 mate with ring electrical contacts 26 at the second side of the ring socket 16 (see FIG. 17).

The module housing 134 can perform several functions. For instance, the module housing 134 can retain the module electrical contacts 124 of each row of the electrical interconnect module 110. The module housing 134 can also provide a mechanical link to position and hold each row of module electrical contacts 124 relative to each other. The module housing 134 can also provide an enclosure that defines the module internal void 185 to protect or to seal the internal components of the electrical interconnect module 110 from the environment, and provide mechanical support for the cables 122.

With continuing reference to FIGS. 17-18B, the electrical cables 122 and the module housing 134 are configured to be mounted to opposed major surfaces of the module substrate 132. The module substrate 132 defines a first major surface 225 and a second major surface 227 opposite the first major surface along the transverse direction T. The first major surface 225 can be an upper major surface, and the second major surface 227 can be a lower major surface that is spaced from the first major surface 225 in the mating direction. Thus, the first major surface 225 can be spaced from the second major surface 227 in the unmate direction. The second major surface 227 can face the host substrate 20 when the electrical interconnect module 110 is mated to the ring socket 116. The electrical cables 122 can be mounted to the first major surface 225 of the module substrate 132. The module housing 134 and module electrical contacts 124 can be mounted to the second major surface 227 of the module substrate 132. The first and second major surfaces 225 and 227 can be defined by the longitudinal direction L and the lateral direction A, and thus can be perpendicular to the transverse direction T.

The electrical interconnect module 110 can also include an electrically insulative module cover 211 that is configured to be mounted to the first major surface 225 of the module substrate 132. The cover 211 can include a base 213, and first and second arms 212 that are opposite each other along the lateral direction A and extend from the base 213. The arms 212 extend from the base 213 in the downward mating direction, and are elongate along the longitudinal direction L. The arms 212 can be spaced from each other a sufficient distance such that the cables 122 can be disposed between the arms 212 when the cover 211 is mounted to the module substrate 132. The base 213 can extend out from the arms 212 in the longitudinal direction L so as to define an overhang 215. The overhang 215 can extend in the longitudinally forward direction in one example. The overhang 215 can define an inner surface 214 that faces the module substrate 132.

The arms 212 are mounted to the first major surface 225 of the module substrate 132, such that the base 213 is spaced from the module substrate 132 along the transverse direction. The electrical cables 122 extend between the base 213 and the module substrate 132, and terminate at locations whereby the electrical cables 122 mount to the first major surface 255 of the module substrate 132. The module housing 134 can be mounted to the module substrate 132, and in particular to the second major surface 227 of the module substrate 132 in the manner described above. Thus, the base 199 and the outer frame 130 can extend out from the second major surface 227 in the mating direction.

The interconnect module 110 can include an organizer clip 252 that is disposed between the overhang 215 and the first major surface 225 of the module substrate 132 with respect to the transverse direction T. The organizer clip 252 can cooperate with the cover 121 to organize a first row of the cables 122, and the organizer clip 252 can cooperate with the first major surface 225 of the module substrate 132 to organize a second row of the cables 122. Thus, the cables 122 can extend through the clip 252 along the longitudinal direction L to respective locations between the arms 212, where the cables 122 are mounted to the module substrate 132. The first and second rows of the cables 122 can be spaced from each other along the transverse direction. In one example, the cover 211 can include a plurality of cover grooves 250 that extend into a surface of the overhang 215 that faces the mating direction, and thus faces the module substrate 132, along the transverse direction T. The cover grooves 250 can be elongate along the longitudinal direction L. The organizer clip 252 can define a first row of clip grooves 251 that extend into a first surface of the organizer clip 252 that faces the cover 211 along the transverse direction. For instance, the first surface of the organizer clip 252 can face the overhang 215. The first row of clip grooves 251 can be aligned with respective ones of the cover grooves 250, such that aligned pairs of the first row of clip grooves 251 and the cover grooves 250 receive respective ones of the first row of the cables 122. The cables 122 of the first row are thus captured between respective aligned ones of the cover grooves 250 and the first row of clip grooves 251. The organizer clip 252 can define a second row of clip grooves 253 that extend into a second surface of the organizer clip 252 that faces the module substrate 132 along the transverse direction. For instance, the second surface of the organizer clip 252 can face the first major surface 225 of the module substrate 132. The clip grooves 253 of the second row of clip grooves 253 can be sized such that the cables 122 of the second row are captured by respective ones of the clip grooves 253 and the module substrate 132. The cables 122 can be configured as coaxial cables or twinaxial cables as desired.

It should be appreciated that the organizer clip 252 can also provide strain relief to the cables 122. In particular, the organizer clip 252 can cooperate with the cover 121 to provide compression against the outer insulative jackets of the cables 122 of the first row. Accordingly, pulling forces applied to the cables 122 of the first row will be absorbed by either or both of the organizer clip 252 and the cover 121. Thus, the pulling forces will not act on the mounting interface between the respective electrical conductors of the cables 122 and the substrate 132. Similarly, the organizer clip 252 can cooperate with the substrate 132 to compress the cables 122 of the second row. Accordingly, pulling forces applied to the cables 122 of the second row will be absorbed by either or both of the organizer clip 252 and the substrate 132. Thus, the pulling forces will not act on the mounting interface between the respective electrical conductors of the cables 122 and the substrate 132. In this regard, the organizer clip 252 can also be referred to as a strain relief clip. The cover 121 can also be referred to as a strain relief member that cooperates with the strain relief clip to provide strain relief to the cables 122 of the first row.

For instance, referring to FIG. 18C, it should be appreciated that the cables 122 can be organized in accordance with any suitable alternative example as desired. As shown, the cables 122 can be configured as twinaxial cables, or can be configured as coaxial cables as desired. The cover 211 can define cover grooves 257 sized to receive respective ones of the twinaxial cables 122. The cover 211 can be devoid of the overhang 215. Instead, the arms 212 can extend to the rear end of the cover 211. The cover 211 can be configured to organize the cables 122 and route the cables 122 to the module substrate 132 where the cables 122 are mounted. The cover 211 can defines cover grooves 257 that extend into a surface of the cover 211 that faces the module substrate 132. The cover grooves 257 can be elongate along the longitudinal direction L so as to guide the received cables 122 in the forward direction to a location between the arms 212, where the cables 122 are mounted to the module substrate 132. Further, the surface of the cover 211 can abut the module substrate 132. The cover grooves 257 can be sized so as to receive respective ones of the cables 122. The signal conductors of the twinaxial cables can be adjacent each other along the lateral direction A as they are received in the cover grooves 257. It should be appreciated that the cover grooves 257 can be sized in any manner as desired. In one example, each of the cover grooves 257 can be sized to receive one or more of the cables 122 as desired. For instance, each of the cover grooves 257 can be sized to receive first and second ones of the cables 122 as desired. In particular, each of the cover grooves 257 can be sized to receive a pair of cables 122 that are aligned with each other along the transverse direction T. Further, each of the cover grooves 257 can be sized to receive first and second pairs of cables 122 that are aligned with each other along the transverse direction T. The first and second pairs can be immediately adjacent each other along the lateral direction A. Immediately adjacent pairs of cables 122 means that no other ones of the cables 122 are disposed between the immediately adjacent pairs of cables. As shown, different first and second immediately adjacent pairs cables 122 that are aligned with each other along the transverse direction T are received in respective ones of the cover grooves 257, and terminate at respective locations between the base 213 and the module substrate 132 with respect to the transverse direction T.

It should be appreciated that the cover 121 can also provide strain relief to the cables 122. In particular, the cover 121 can cooperate with the module substrate 132 to provide compression against the outer insulative jackets of the cables 122 received in the grooves 257. Accordingly, pulling forces applied to the cables 122 will be absorbed by any one, two, or all of the organizer clip 252, the module substrate 132, and an adjacent one of the cables 122. Thus, the pulling forces will not act on the mounting interface between the respective electrical conductors of the cables 122 and the substrate 132.

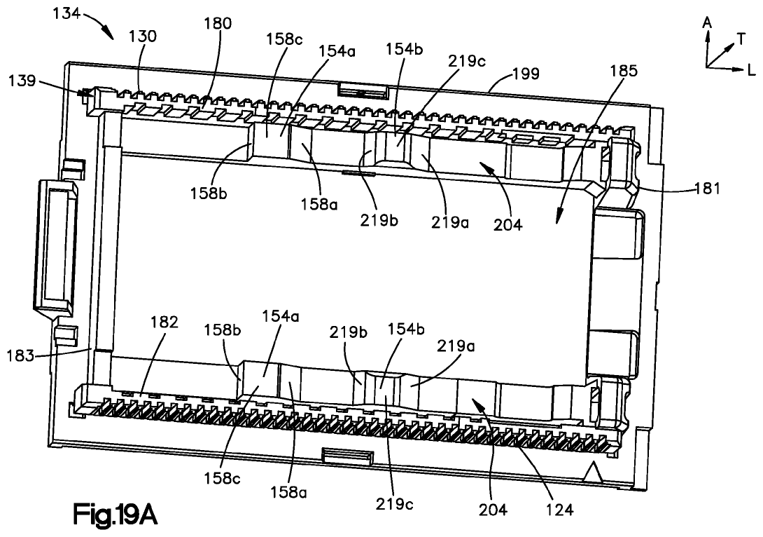

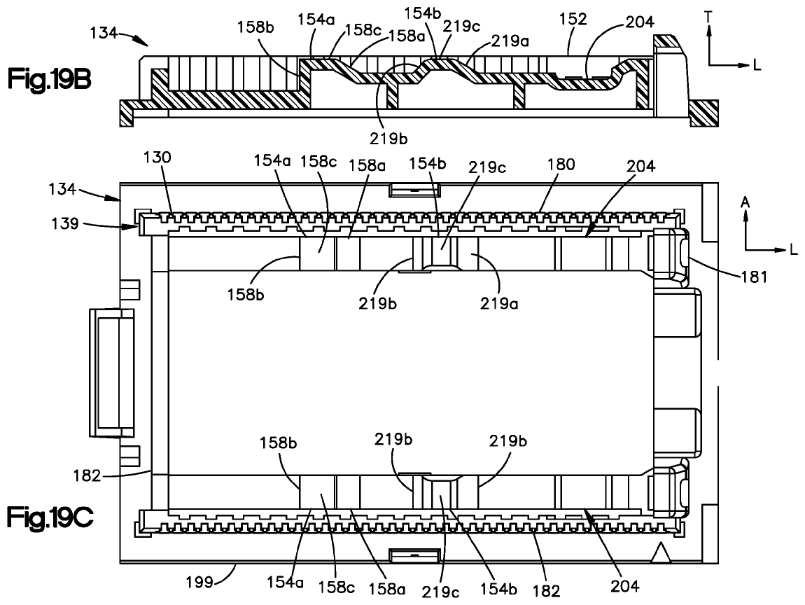

Referring now to FIGS. 18A-19C, the outer frame 130 and thus the module housing 134 can include at least one rail 204, such as first and second rails 204, that are configured to engage respective arms 44 of the latch 18 of the ring socket 16 as described above with respect to FIG. 14. In particular, each rail 104 can include a plurality of protrusions configured to interface with the latch of the mated ring socket 16 so as to selectively secure the interconnect module 10 to the ring socket 16. The rails 104 can be opposite each other along the lateral direction A. The rails 204 can be disposed laterally inward with respect to the module sides 180 and 182, respectively (see FIG. 18A). Thus, the rails 204 can be disposed between the module sides 180 and 182 with respect to the lateral direction A (see FIG. 18A). The rails 204 can be monolithic with the module sides 180 and 182, or can alternatively be a separate structure from either or both of the module sides 180 and 182. In this regard, the rails 204 can be independently mounted to the module substrate 132 as desired.

Each of the rails 204 can define at least one protrusion such as a first protrusion 154a and a second protrusion 154b spaced from the first protrusion 154a in the forward direction. The first and second protrusions 154a and 154b can extend in the downward direction. The first protrusion 154a can define a first leading ramped rail surface 158a that extends upward as it extends in the forward direction, and a first trailing rail surface 158b that can be oriented substantially along the transverse direction T or can be ramped. The first protrusion 154a can define a first rail flat 158c that extends between the first leading ramped rail surface 158a and the first trailing rail surface 158b. The second ramp protrusion 154b can define a second leading ramped rail surface 219a that extends upward as it extends in the forward direction, and a second trailing ramped rail surface 219b that extends downward as it extends in the forward direction. The second protrusion can define a second rail flat 219c that extends between the second leading ramped rail surface 219a and the second trailing ramped rail surface 219b.

Operation of the latch 18 of the ring socket 16 and the rails 204 of the electrical interconnect module 110 will now be described in detail with respect to FIGS. 20A-20C. In particular, the ring socket latch 18 is movable with respect to the rails 204 between the accept position, the locked position, and the eject position. The rails 204 can remain stationary as the latch 18 moves between its various positions. As shown in FIG. 20A the interconnect module 110 is mated with the ring socket 16 with the ring socket latch 18 in the accept position. When the ring socket latch 18 is in the accept position, the dimples 49 of the module latch arms 44 can be disposed in the first pockets 51a, respectively. Alignment of the dimple 49 with the first pocket 51a helps to register the ring socket latch 18 in the accept position. The accept position may be an intermediate position between the minimal spacing and the maximum spacing of the latch actuator 19 from the ring socket housing 50. The first pocket 51a can be sized and positioned such that the dimples 49 abut the ring socket housing 50 at a forward end of the first pocket 51a when the dimples 49 attempt to travel in the forward direction a sufficient distance to move the ring socket latch 18 to the locked position. The abutment between the ring socket housing 50 at the first end of the first pockets 51a and the dimples 49 prevent the ring socket latch 18 from inadvertently moving to the locked position. Further, when the ring socket latch 18 is disposed in the accept position, each of the first upward lifters 46a of the latch 18 is disposed between the first and second protrusions 154a and 154b of the rails 204, respectively, with respect to the longitudinal direction L. Further, each of the second upward lifters 46b of the latch 18 can be spaced from the second protrusion 154b in the forward direction.

When the latch 18 is in the accept position shown in FIG. 20A, the locking bar 40 (see FIG. 14) of the ring socket latch 18 is spaced from the body ledge 141 of the locking projection 138 (see FIG. 18A) of the module housing 134. Thus, the first interference is removed. Additionally, when the latch 18 is in the accept position, the end portions 59 of the latch arms 44 can be spaced in the rearward direction from the abutment members 145 of the interconnect module housing 134, and thus out of alignment with the abutment members 145. Thus, the second and third interferences are removed. Accordingly, the latch 18 does not prevent the electrical interconnect module 110 from being mated to the ring socket 16 in the manner described above. It is recognized that the mated electrical interconnect module 110 can be removed from the ring socket 16 when the latch 18 is in the accept position. However, the latch 18 does not urge the electrical interconnect module 110 to unmate from the ring socket 16 when the latch 18 is in the accept position. Rather, as described below, the latch 18 can urge the mated interconnect member 110 out of the ring socket 16 when the latch 18 is in the eject position.

Referring now to FIG. 20B, when an actuation force is applied to the latch 18, and for instance to the latch actuator 19, in the first or forward direction toward the interconnect module housing 134, the latch 18 can move from the accept position shown in FIG. 20A to the locked position shown in FIG. 20B. The latch actuator 19 is disposed closer to the ring socket housing 50 in the locked position compared to when the latch actuator 19 is in the accept position. As described above, when the latch 18 is in the locked position, the interferences can be engaged. In particular, the locking bar 40 (see FIG. 14) of the ring socket latch 18 is inserted into the opening of the locking projection 138 (see FIG. 18A). Thus, the locking bar 40 is aligned with the body ledge 141 of the locking projection 138 (see FIG. 18A) in the upward direction, which is directed away from the host substrate 20. Because the body ledge 141 is located at a rear end of the interconnect module 10, interference between the locking bar 40 and the body ledge 141 prevents the rear end of the electrical interconnect module 110 from being removed from the ring socket 16. Further, the end portions 59 of the latch arms 44 are driven to a position in alignment with the respective abutment members 145 of the interconnect module housing 34. In particular, the end portions 59 are adjacent the abutment members 145 in the upward direction. Because the abutment members 145 of the interconnect module housing 134 can be located at a front end of the interconnect module housing 134, interference between the locking bar end portions 59 of the larch arms 44 and the abutment members 145 prevent the front end of the interconnect module 10 from being removed from the ring socket 16.

When the latch 18 moves from the accept position to the locked position, the dimple 49 translates out of the first pocket 51a, and into the second pocket 51b. Abutment between the latch arms 44 and either or both of the interconnect module housing 134 and the ring socket housing 50 can limit movement of the latch 18 in the forward direction as it moves from the accept position to the locked position. For instance, the leading first upward lifters 46a of the latch arms 44 can abut the second protrusions 154b, respectively, of the rails 204. In particular, the first leading ramped latch surfaces 107a of the first upward lifters 46a can abut the second trailing ramped rail surfaces 119b of the second protrusions 154b. Further, the downward lifter 105 of each latch arm 44 can abut the at least one housing stop surface 122. In particular, the leading ramped downward lifter surface leading 105a of the downward lifter 105 can abut the at least one housing stop surface 122. Interference between the dimple 49 and the rear end of the second pocket 51b can prevent the inadvertent movement of the latch 18 from the locked position shown in FIG. 20B to the accept position shown in FIG. 20A.

Referring now to FIGS. 20B-20C, the latch 18 can move from the locked position to the accept position and then to the eject position. In particular, a force is applied to the latch 18 in the rearward direction sufficient to cause the latch 18 to move in the rearward direction from the locked position to the accept position, and from the accept position to the eject position. In particular, the force is sufficient to cause the dimple 49 to move from the second pocket 51b to the first pocket 51a. The force is further sufficient to cause the dimple 49 to move from the first pocket 51a to a position spaced from the first pocket 51a in the rearward direction when the latch 18 is in the eject position shown in FIG. 20C.

Referring now to FIG. 20C in particular, when the latch 18 is moved to the eject position, the interferences are removed in the manner described above with respect to the accept position. Further, the first upward lifters 46a of the latch arms 44 ride in the rearward direction along the first protrusions 154a of the interconnect module housing 134. In particular, the first trailing ramped latch surface 107b of the first upward lifter 46a rides along the first leading ramped rail surface 158a of the first protrusion 154a. This causes the latch arm 44 to urge a rear portion of the interconnect housing 134, and thus the interconnect module 110 to move away from the ring socket 16 in the upward unmate direction until the first upward lifter 46a rests against the flat 158c of the first protrusion 154a.

Further, with continuing reference to FIG. 20C, the trailing ramped downward lifter surface 105b of the downward lifter 105 of each latch arm 44 rides in the rearward direction from the accept position along the respective at least one ramped housing surface 120. The downward lifters 105 can rest on the ramped housing surfaces 120, respectively, which further causes the rear portion of the interconnect module 110 to move away from the ring socket 16 in the upward unmate direction.

Additionally, the first upward lifters 46a and the downward lifter 105 ride along the first protrusions 154a and the ramped housing surfaces 120, respectively, which cause the second upward lifters 46b of the latch arms 44 to ride in the rearward direction along the second protrusions 154b of the interconnect module housing 134. In particular, the second trailing ramped latch surface 109b of the second upward lifters 46b ride along the second leading ramped rail surface 219a of the second protrusion 154b. This causes the latch arm 44 to begin urging a front portion of the interconnect housing 134, and thus the interconnect module 110 to move away from the ring socket 16 in the unmate direction. However, as the first upward lifter 46a and the downward lifter 105 of the latch arms 44 continue to ride along the first protrusion 154a and the ramped housing surface 120, respectively, the front portion of the interconnect module can move out of the ring socket 16, which causes the second protrusion 154b to become spaced from the second lifter 46b in the upward unmate direction. In one example, this can cause the latch arms 44 to elastically flex, and return to its initial shape after the interconnect module 10 is removed from the ring socket 16. Once the interconnect module 110 has been ejected from the ring socket 16 by the latch arms 44, the interconnect module 110 can be easily removed from the ring socket 16. It is appreciated that the latch arms 44 may not fully eject the interconnect module 110 completely out of the ring socket 16, but ejects the interconnect module 110 a sufficient distance in the unmate direction so that the interconnect module can be easily removed from the ring socket 16.

Referring again to FIGS. 20A-20C, the longitudinally forward direction can be referred to as a locking direction whereby the latch 18 moves from the accept position to the locked position, and the longitudinally rearward direction can be referred to as an ejecting direction whereby the latch 18 moves from the locked position to the eject position. It should be readily appreciated in other examples that the latch arms 44, the rails 204, and the ring socket housing 50 can be configured such that the forward direction defines the ejecting direction, and the rearward direction defines the locking direction. It can be advantageous, however, in some examples for the rearward direction to define the ejection direction. In particular, the latch 18 can experiences the highest forces when moving the latch 18 to the ejection direction. Rearward motion of the latch 18 is effected by a pulling force in the rearward direction, which can better maintain the structural integrity of the latch with respect to a forward motion of the latch 18 effected by a pushing force that would move the latch 18 in the ejection direction.

The terms “upward,” “upper,” “up,” “above,” and derivatives thereof are used herein with reference to the upward direction. The terms “downward,” “lower,” “down,” “below,” and derivatives thereof are used herein with reference to the downward direction. Of course, it should be appreciated that the actual orientation of the interconnect module assemblies shown in FIGS. 1A and 17 can vary during use, and that the terms upward and downward and their respective derivatives can be consistently used as described herein regardless of the orientation of the vertical insertion interconnect system and components thereof during use.

It should be appreciated that the illustrations and discussions of the embodiments shown in the figures are for exemplary purposes only and should not be construed limiting the disclosure. One skilled in the art will appreciate that the present disclosure contemplates various embodiments. Additionally, it should be understood that the concepts described above with the above-described embodiments may be employed alone or in combination with any of the other embodiments described above. It should be further appreciated that the various alternative embodiments described above with respect to one illustrated embodiment can apply to all embodiments as described herein, unless otherwise indicated.

1. An interconnect module configured to mate with a ring socket, the interconnect module comprising:
a module substrate;
a module housing mounted to the module substrate, the module housing defining first and second opposed ends and first and second opposed sides that extend between the first and second opposed ends; and
a plurality of module electrical contacts that are arranged in first and second rows along the first and second opposed sides, respectively,
wherein the module housing is configured to engage a ring socket latch of the ring socket so as to be configured to selectively 1) mate with and unmate from the ring socket when the latch is in a first position, 2) secure to the ring socket when the latch is in a second position, and 3) eject from the ring socket when the latch is in a third position.

2. The interconnect module as recited in claim 1, wherein the module housing is configured to be received by the ring socket when the ring socket latch is in the first position.

3. The interconnect module as recited in claim 1, wherein the module housing comprises protrusions that are configured to abut respective raised portions of the ring socket latch so as to eject the interconnect module from the ring socket.

4. The interconnect module as recited in claim 2, wherein first and second ones of the protrusions are spaced from each other along the longitudinal direction, such that the ring socket module latch is translatable along the longitudinal direction between the first, second, and third positions.

5. The interconnect module as recited in claim 2, wherein the module housing comprises first and second rails that each defines respective first and second ones of the protrusions.

6. The interconnect module as recited in claim 2, wherein each of the protrusions defines a ramp surface.

7. The interconnect module as recited in claim 1, wherein the first and second opposed ends of the module housing are configured to be secured to the ring socket latch when the ring socket latch is in the second position.

8. The interconnect module as recited in claim 7, wherein the module housing comprises a body ledge that is configured to abut a locking bar of the ring socket latch when the ring socket latch is in the second position, so as to prevent the interconnect module from being unmated from the ring socket.

9. The interconnect module as recited in claim 8, wherein the ring socket comprises a channel in the module housing that defines the body ledge.

10. The interconnect module as recited in claim 7, further comprising an abutment member configured to abut a forward portion of the ring socket latch when the ring socket latch is in the second position, so as to prevent the interconnect module from being unmated from the ring socket.

11. The interconnect module as recited in claim 10, wherein the module housing defines a channel sized to receive the forward portion of the ring socket latch, wherein the channel defines the abutment member.

12-14. (canceled)

15. The interconnect module as recited in claim 1, further comprising a cable latch supported by the module housing and movable between an open position and a closed position, whereby in the open position the interconnect module is configured to receive a detachable cable assembly, and in the closed position the cable latch is configured to secure the received detachable cable assembly to the interconnect module.

16. The interconnect module as recited in any one of claim 15, wherein the detachable cable assembly comprises a cable and a cable ferrule that terminates an end of the cable, and the cable ferrule is a MT ferrule that registers end faces of a plurality of optical fibers relative to two precision holes or dowels that are in or supported by the MT ferrule.

17-18. (canceled)

19. The interconnect module as recited in claim 16, wherein the cable latch rotates about a pivot axis between the open position and the closed position.

20. The interconnect module as recited in claim 19, comprising a pivot axle supported by the module housing, wherein cable latch is coupled to the pivot axle, and the pivot axle defines the pivot axis.

21. (canceled)

22. The interconnect module as recited in claim 20, wherein the pivot axle is movable along a longitudinal direction within the frame slot.

23. (canceled)

24. The interconnect module as recited in claim 22, wherein the cable latch includes at least one compression member configured to apply a retention force against the cable assembly that retains the cable assembly when the cable latch is in the closed position.

25. The interconnect module as recited in claim 24, wherein the compression member is configured to apply a retention force against a surface of the ferrule, and the compression member passes over an entirety of the surface of the ferrule when the cable latch moves from the open position to the closed position, and when the cable latch moves from the closed position to the open position.

26-125. (canceled)

126. A ring socket comprising:
an electrically insulative ring socket housing having first and second ends opposite each other along a longitudinal direction, and first and second sides opposite each other along a lateral direction that is perpendicular to the longitudinal direction, wherein the sides that extend between the opposed ends so as to define a rectangular opening;
first and second rows of electrical contacts supported by the first and second sides, respectively, of the ring socket housing; and
a ring socket latch that is movable between an accept position whereby the ring socket is configured to mate with an interconnect module, a locked position whereby the ring socket is secured to the mated interconnect module so as to prevent the interconnect module from being unmated from the ring socket, and an eject position whereby the ring socket ejects the interconnect module.

127-157. (canceled)

158. A method of securing a cable ferrule that has been inserted into an interconnect module in an insertion direction, the method comprising the steps of:
rotating a cable latch of the interconnect module in a first direction of rotation about a pivot axis from an open position toward a closed position, wherein the cable latch is pivotally coupled to a housing of the interconnect module about the pivot axis;
during the rotating step, causing a compression member of the cable latch to move past an edge of the ferrule that is defined by an intersection of a face of the ferrule and a top surface of the ferrule;
after the causing step, causing the compression member to compress against the ferrule along a longitudinal direction that includes the insertion direction, thereby causing the compression member to apply a compression force to the face of the ferrule that retains the ferrule in the interconnect module.

159-194. (canceled)
